(19) United States
(12) Patent Application Publication
(10) Pub. No.: US 2024/0091944 A1
(43) Pub. Date: Mar. 21, 2024

(54) SAFETY SYSTEMS AND METHODS EMPLOYED IN ROBOT OPERATIONS

(71) Applicant: REALTIME ROBOTICS, INC., Boston, MA (US)

(72) Inventors: Scott Hopkinson, Concord, MA (US); Jenni Lam, Boston, MA (US); Venkat K. Gopalakrishnan, Lexington, MA (US); Arne Sieverling, Berlin (DE)

(21) Appl. No.: 18/520,298

(22) Filed: Nov. 27, 2023

Related U.S. Application Data
(63) Continuation of application No. 17/506,364, filed on Oct. 20, 2021.
(60) Provisional application No. 63/105,542, filed on Oct. 26, 2020.

(51) Int. Cl. B25J 9/16; B25J 13/08

(52) U.S. Cl. CPC B25J 9/1676; B25J 13/08

(57) ABSTRACT

A safety system for use in robotics includes a plurality sensors, preferably a heterogeneous set of commercial off the shelf sensors, and at least one processor that assesses an operational state of the sensors, validates a system status based on the assessed operational states of the sensors to determine whether sufficient sensors are operable to provide a safety certified system, and monitors an operational environment for violations of safety rules that specify rules regarding proximity of humans to robots. A control system for use in robotics includes at least one processor that performs motion planning taking into account safety monitor rules implemented by the safety system to thereby reduce triggering of stoppages, slowdowns or precautionary occlusions by the safety system.

### TECHNICAL FIELD

The present disclosure generally relates to robots, and in particular to safety systems and methods used in robot operation, for instance in conjunction with a robot control system which may itself employ motion planning to produce motion plans to drive robots in operational environments.

### BACKGROUND

### Description of the Related Art

Robots are becoming increasing ubiquitous in a variety of applications and environments.

Typically, a robot control system performs motion planning and/or control of the robot(s). The robot control system may, for example take the form of a processor-based system, typically with one or more sensors (e.g., cameras, contact sensors, force sensors, encoders). The robot control system may determine and/or execute motion plans to cause a robot to execute a series of tasks. Motion planning is a fundamental problem in robot control and robotics. A motion plan specifies a path that a robot can follow from a starting state to a goal state, typically to complete a task without colliding with any obstacles, including humans, in an operational environment or with a reduced possibility of colliding with any obstacles in the operational environment. Challenges to motion planning involve the ability to perform motion planning at very fast speeds even as characteristics of the environment change. For example, characteristics such as location or orientation of one or more obstacles in the environment may change over time. Challenges further include performing motion planning using relatively low cost equipment, at relative low energy consumption, and with limited amounts of storage (e.g., memory circuits, for instance on processor chip circuitry).

Safety of robot operation, and in particular safe movement of a robot or portion thereof, is typically a significant concern where a human, for example a robot operator, enters or may enter an operational environment in which one or more robots operate.

A dedicated safety system may be employed in situations where safety is a concern. The dedicated safety system may be in addition to the robot control system that performs motion planning and/or control of the robot(s). The dedicated safety system may, for example take the form of a processor-based workcell safety system, typically with one or more sensors (e.g., cameras). The processor-based workcell safety system monitors the operational environment for hazards, and particularly for the presence of a human or an object that may be a human.

Safety systems used in robotics may be safety certified, in which case they usually employ multiple safety certified sensors. Increasing the number of such safety certified sensors typically reduces the possibility of occlusions, that is areas that are occluded from view of the sensors. However, safety certified sensors are very expensive as compared to more common commercial off-the-shelf (COTS) sensors. Thus, there is often a difficult balance between the desire to add safety certified sensors in order to reduce occurrences of occlusion and the significant cost of adding more safety certified sensors to a safety certified safety system.

Processor-based workcell safety systems typically operate by triggering safety related stoppages or slowdowns of robot operation when the safety system detects certain safety related conditions, for instance the detection of a human in proximity of a robot or trajectory of a robot. While helpful in preventing accidents, unnecessary stoppages or slowdowns adversely affect overall performance of the robot(s).

### BRIEF SUMMARY

It would be advantageous to achieve a safety certified safety system using multiple COTS sensors, which are typically substantially less costly than safety certified sensors. It would also be advantageous to reduce or even eliminate a total number and/or durations of stoppages or slowdowns of the robot operations.

A processor-based workcell safety system may be considered as comprised of two portions: sensors positioned and oriented to monitor at least a portion of an operational environment or workcell; and a processor-based system communicatively coupled to the sensors and which processes sensor data provided by the sensors. Some implementations may include additional types of sensors that detect when a human has entered an operational environment, but not necessarily a position or location of the human in the workcell. Such sensors may; for example, include one or more of: a radio frequency identification (RFID) interrogation system that detects RFID transponders worn by humans, a laser scanner, a pressure sensor, and/or a passive infrared (PIR) motion detector that detect the presence of a human in the workcell.

In most situations, a position and orientation of the robot(s) is known to a processor, for example based on known joint angles of the robot(s), or such information can obtained in a safety certifiable manner. If the processor-based workcell safety system were to lose track of a static object (e.g., table), that is not typically considered a safety hazard because the static object will generally not hit a human. Thus, for safety certification, the primary issue is tracking where one or more humans are in an operational environment in which one or more robots operate.

It may be acceptable for the safety system to lose track of the human(s) for a very short amount of time (i.e., an amount of time that is less than an amount of time that could lead to a collision between the human and a robot). Put another way, there will always be some amount of uncertainty about the position of a human (e.g., due to sensor noise, sampling rate, occlusions). The longer that a position of a human remains unknown to the system, the larger the region of uncertainty (i.e., the region in which the human could be) grows over time. For example, if the location of the human were not known for a period of time, then the human could be in an unknown position that is within a range of, for instance, about 2 meters/second multiplied by the amount of time since position of the human was last known. For safety purposes, a processor-based workcell safety system could cause the entire workcell or operational environment to be treated as if a human was present in that region. While such would err on the side of caution, such treatment would likely have an adverse effect on motion planning and robot operation. Alternatively, if the position of the human is lost for some period of time thereby increasing the region of uncertainty, the processor-based workcell safety system may provide an indication that the region of uncertainty should be treated as occluded during motion planning and/or execution or movement of the robot(s).

To ensure safety, both functional aspects of a processor-based workcell safety system (i.e., sensing and processing) must be considered safe.

With respect to processing, various approaches may be employed. For example, a system may employ dual modular redundancy (DMR). DMR suffices because if the two modules disagree, such is treated as having detected a problem and robot operation ceases, is slowed, or an occluded area is introduced to the motion planning. Also for example, a processor-based workcell safety system may employ triple modular redundancy (TMR), where a system uses the output of a majority of modules (e.g., where two of three modules are in agreement, the system uses the output of the modules that are in agreement).

With respect to sensing, it would be advantageous to mitigate failure modes of sensor data, for example by employing one or more failure mode and effects analysis (FMEA) processes or techniques. Some example failure modes and effects analysis processes or techniques are described below, for illustrative purposes.

One possible failure mode effects analysis approach or technique is to confirm that the safety system is receiving sensor data (e.g., images) as expected, for example that a processor of the safety system is receiving the sensor data when the processor of the safety system should be receiving sensor data from the sensors. For instance, if the sensor is an image sensor that samples or captures images at 30 Hz, the processor of the safety system should receive an image every 1/30 of a second. Such can, for example be checked or validated via a watchdog mechanism. Notably, such a check does not detect when a sensor becomes stuck (e.g., erroneously repeatedly or continually sending the same stale sensor data even though the sensed portion of the operational environment has changed).

Another possible failure mode effects analysis approach includes closing the loop on the sensor data, for instance determining whether the sensor data makes sense given a known situation or is consistent with a known situation (e.g., is the sensor data consistent with what is known about the position, orientation, and/or movement of various objects in the operational environment including the robot(s) and/or fiducials and including the sensors). Any one or more of the following approaches may be employed to determine whether the sensor data is consistent with or makes sense given a known situation.

The processor-based workcell safety system may advantageously employ multiple heterogeneous sensors to monitor an operational environment. The heterogeneous sensors may include sensors that are of different sensor modalities (e.g., different modes of operation) from one another, that are at different vantage points or otherwise have different fields of view from one another, that have different sampling rates from one another, and/or are that are from different manufacturers from one another or different models from one another. For example, a processor-based workcell safety system may employ multiple sensors that have different sensing modalities from one another (e.g., 1D laser scanner, two-dimensional (2D) camera, three-dimensional (3D) camera, time-of-flight camera, heat sensor). Each of these sensors itself is not exceptionally reliable or is not safety certified. Each sensor has a sampling rate (e.g., frame rate, image capture rate) at which the sensor captures a sample (e.g., captures an image, captures a distance measurement, captures a three-dimensional representation) in some format. Each sample depends on the sensing modality. While the use of heterogeneous sensors may hinder maintenance and thus may normally be avoided, heterogeneous sensors (e.g., diversity in sensor modality, spatial (different vantage points), temporal (different times), manufacturer, model) is particularly advantageous where COTS sensors are to be employed in realizing a safety certified processor-based workcell safety system. The diversity protects against common-mode failures (e.g., two sensors at same vantage point miss the same voxel, two sensors of same modality fail in same operating environment in the same way or due to the same condition).

If two or more sensors capture overlapping regions of the operational environment (also referred to as a workcell), the processor-based workcell safety system can compare the sensor data from two or more sensors to infer the possibility of a fault existing. For instance, images captured by two or more image sensors may be compared. With only two sensors, the processor-based workcell safety system would not know which of the sensors is faulty or even if both sensors are faulty. However, it would be apparent the two sensors could not be trusted. In response, the processor-based workcell safety system could cause robot operation or movement to stop or slow down to ensure safety. Alternatively, the processor-based workcell safety system could cause the area or region monitored by the two sensors to be indicated as being occluded for motion planning purposes, thereby achieving an increased level of safety without completely stopping operation or movement of the robot(s). If three or more sensors capture overlapping regions of the operational environment, the processor-based workcell safety system can compare the sensor data from the three or more sensors, determining whether sensor data from a majority of the sensors is consistent with one another or in agreement with one another. The processor-based workcell safety system may then infer that those sensors in the minority cannot be trusted and take action based on sensor data from the majority of sensors that are in agreement.

Some implementations may advantageously use one or more fiducials that move in a known or knowable (e.g., sensed) way to determine whether the sensor data received from one or more sensors makes sense. For example, the processor-based workcell safety system may know a position, location and/or movement (e.g., direction and/or magnitude) of a fiducial. For instance, the processor-based workcell safety system may know that a given fiducial moves 1 cm to the right during a given period of time. The processor-based workcell safety system may then know or determine what effect the known movement of the fiducial should have on the perception of that fiducial by any given sensor. For instance, the processor-based workcell safety system may compare a “before-the-move” image to an “after-the-move” image, to detect certain faults in a given sensor. For example, such a comparison may advantageously allow the processor-based workcell safety system to determine that a given sensor is stuck, erroneously repeatedly sending the same stale image data (e.g., images) over and over again, even though a position of objects in the field of view of the sensor have changed over the relevant time period. Such may, for instance, be indicated by a sensor that always senses something in a same position (e.g., a top right square centimeter in the field of view of the sensor) over a duration of time during which a portion of the operational environment monitored by the sensor has changed. A robot or portion thereof can serve as a fiducial if there exists a safety certifiable knowledge of the states or configurations of the robot (e.g., if the robot provides joint angles in a safety certified way or by some other mechanism). Since the processor-based workcell safety system knows where the robot or portion thereof that comprises or carries a fiducial is supposed to be in space at each instance of time when the sensor data is acquired, the processor-based workcell safety system can verify the sensors that observe the robot are working correctly.

Some implementations may employ one or more fixed fiducials, with one or more sensors that move in a safety certified known or knowable manner. If movement of the sensor(s) is known (e.g., the joint positions of a robot that carries the sensor is known or can be queried in a safety certified way, or a number of rotations of a motor that moves the sensor is known or can be queried in a safety certified way), the processor-based workcell safety system can compare sensor data collected before and after movement of the sensor to detect faults, for example by comparing an image captured after the movement with an image captured before the movement of the sensor.

In some implementations, the processor-based workcell safety system may employ a default state that indicates that an entirety of the workcell or operational environment is occluded, relaxing that assumption only upon having sensor data from at least two sensors that is consistent or in agreement with each other that the region is not occluded. This default assumption is obviously pessimistic, but it ensures safety. Other implementations may indicate an area or region of the workcell or operational environment as occluded in response to determining that sensor data from at least two sensors that cover the area or region are inconsistent or not in agreement. As noted, some implementations may operate based on a determination that the sensor data from a majority of sensors is consistent or in agreement with one another.

A multi-faceted FMEA approach including sensor diversity (e.g., temporal, optical, geometric, sensor modality, manufacturer, model), checking for consistency of sensor data with safety certifiable known or knowable information, and/or for consistency or agreement between sensors may advantageously facilitate use of COTS sensors while ensuring that the probability of missing the detection of a human in the operational environment: a) from all of the sensors, b) at the same time, and c) for a persistently long period to cause a robot to run into a human are low enough to pass a sufficiently low risk of hazard for the safety system to be safety certified.

A safety certified operational environment or workcell could be decomposed into: i) a functional system (i.e., robot control system) that operates the robots; and ii) a processor-based workcell safety system that ensures safety. The functional system can include one or more sensors and a processor-based system comprising one or more processors communicatively coupled to the sensors and which perform motion planning and/or control of one or more robots. The processor-based workcell safety system can likewise include one or more sensors and a processor-based system comprising one or more processors communicatively coupled to the sensors and which perform safety analysis. This separation of operations is useful for a variety of reasons, most notably because it enables the design of the functional robot motion planning and/or control system to be independent of the design of the processor-based workcell safety system.

In a safety certified operational environment or workcell, the processor-based workcell safety system triggers a stoppage or slowdown of the robot(s) whenever the functional system causes a robot to get too close to a human as defined by a set of safety rules. The notion of what constitute “too close” is typically dependent on how the safety system is configured and operates. For example, a processor-based workcell safety system may employ a laser scanner to divide a floor into an 8×8 grid of regions, and the safety system is triggered to interrupt robot operation whenever a robot is within one grid region of a human.

The functional system may be designed or configured such that the functional system is aware of, and takes into account, how the processor-based workcell safety system functions, to reduce or even avoid triggering safety-triggered stoppages or slowdowns or precautionary occlusions by operating the robot(s) in a way that is aware of what will trigger the safety system. That is, if the functional system is aware of how the processor-based workcell safety system works and what triggers a stoppage or slowdown or introduction of a precautionary occlusion, the functional system can operate the robot(s) to be less likely to trigger the processor-based workcell safety system. In the above example of a grid generating laser sensor, the functional system would know not to put a robot within one grid region of a human, even if a raw distance between the human and the robot would not necessarily be dangerous. The functional system may, for example, access a set of safety rules and conditions that the processor-based workcell safety system executes or upon which the processor-based workcell safety system relies in detecting violation of the safety rules. Additionally, the functional system may be optimized to also consider an expected or predicted movement of a human when performing motion planning while reducing the probability of triggering the safety system. For example, the functional system may access a model of human behavior. Additionally or alternatively, the functional system may rely on logic that reflects that humans entering an operational environment have been trained according to a set of defined guidelines, so the human is expected to stay within a fairly predictable segment of the operational environment or workcell or otherwise move in a predictable way (e.g., predictable speed or maximum speed). The functional system can take such information into account to generate motion plans in a safety-system-aware manner, that are optionally enhanced by predicted or expected of human behavior. For example, if it is predicted that a human will enter a grid region next to the robot, the functional system can proactively move the robot away to avoid triggering the safety system and in turn avoid a stoppage or slowdown.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram of a robotic system, according to one illustrated implementation, that includes a plurality of robots that operate in an operational environment to carry out tasks, and which includes one or more robot control systems with motion planners that dynamically produce motion plans for the robots, and one or more processor-based workcell safety systems that monitor the operational environment for hazards such as humans entering a path of a robot.

FIG. 2 is a functional block diagram of a processor-based workcell safety system, according to one illustrated implementation, that includes a number of sensors and at least one processor communicatively coupled to the sensors and operable to assess an operational state of the sensors of the safety system, a system status of the safety system to determine whether an anomalous system status exists and to take appropriate action based on the system status, and to monitor the operational environment for occurrence of unsafe conditions.

FIG. 3 is a functional block diagram of a first robot and a robot control system with a motion planner that generates motion plans to control operation of at least the first robot, according to one illustrated implementation.

FIG. 4 is an example motion-planning graph for a robot that operates in an operational environment or workcell, according to one illustrated implementation.

FIG. 5 is a flow diagram showing a high-level method of operation in a processor-based workcell safety system to implement safety monitoring of an operational environment to control robot operation in the operational environment along with validation of a safety monitoring system, according to at least one illustrated implementation.

FIG. 6 is a flow diagram showing a low-level method of operation in a processor-based workcell safety system to implement safety monitoring of an operational environment to control robot operation in the operational environment along with validation of a safety monitoring system, according to at least one illustrated implementation, the low-level method executable as part of executing the high level method illustrated in FIG. 5.

FIG. 7 is a flow diagram showing a low-level method of operation in a processor-based workcell safety system to implement safety monitoring of an operational environment to control robot operation in the operational environment, according to at least one illustrated implementation along with validation of a safety monitoring system, the low-level method executable as part of executing the high level method illustrated in FIG. 5.

FIG. 8 is a flow diagram showing a low-level method of operation of a processor-based robot control system to control robot operation in an operational environment to reduce triggering of a processor-based workcell safety system, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, actuator systems, and/or communications networks have not been shown or described in detail to avoid unnecessarily obscuring descriptions of the embodiments. In other instances, well-known computer vision methods and techniques for generating perception data and volumetric representations of one or more objects and the like have not been described in detail to avoid unnecessarily obscuring descriptions of the embodiments.

Unless the context requires otherwise, throughout the specification and claims that follow, the word “comprise” and variations thereof, such as, “comprises” and “comprising” are to be construed in an open, inclusive sense that is as “including, but not limited to.”

Reference throughout this specification to “one implementation” or “an implementation” or to “one embodiment” or “an embodiment” means that a particular feature, structure or characteristic described in connection with the embodiment is included in at least one implementation or in at least one implementation embodiment. Thus, the appearances of the phrases “one implementation” or “an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification and the appended claims, the terms determine, determining and determined when used in the context of whether a collision will occur or result, mean that an assessment or prediction is made as to whether a given pose or movement between two poses via a number of intermediate poses will result in a collision between a portion of a robot and some object (e.g., another portion of the robot, a portion of another robot, a persistent obstacle, a transient obstacle, for instance a person).

As used in this specification and the appended claims, reference to a robot or robots means both robot or robots and/or portions of the robot or robots.

As used in this specification and the appended claims, the term “fiducial” means a standard of reference, for example an object and/or a mark or set of marks in a field of view of one or more sensors (e.g., images sensor(s) of an imaging system) which appears in the sensor data (e.g., image) produced by the sensor(s), for use as a point of reference or a measure. The fiducial(s) may be either placed into or on one or more robots, or may be mounted to move independently of the robot(s).

As used in this specification and the appended claims, the term “path” means a set or locus of points in two- or three-dimensional space, and the term “trajectory” means a path that includes times at which certain ones of those points will be reached, and may include velocity, and/or acceleration values as well.

The headings and Abstract of the Disclosure provided herein are for convenience only and do not interpret the scope or meaning of the embodiments.

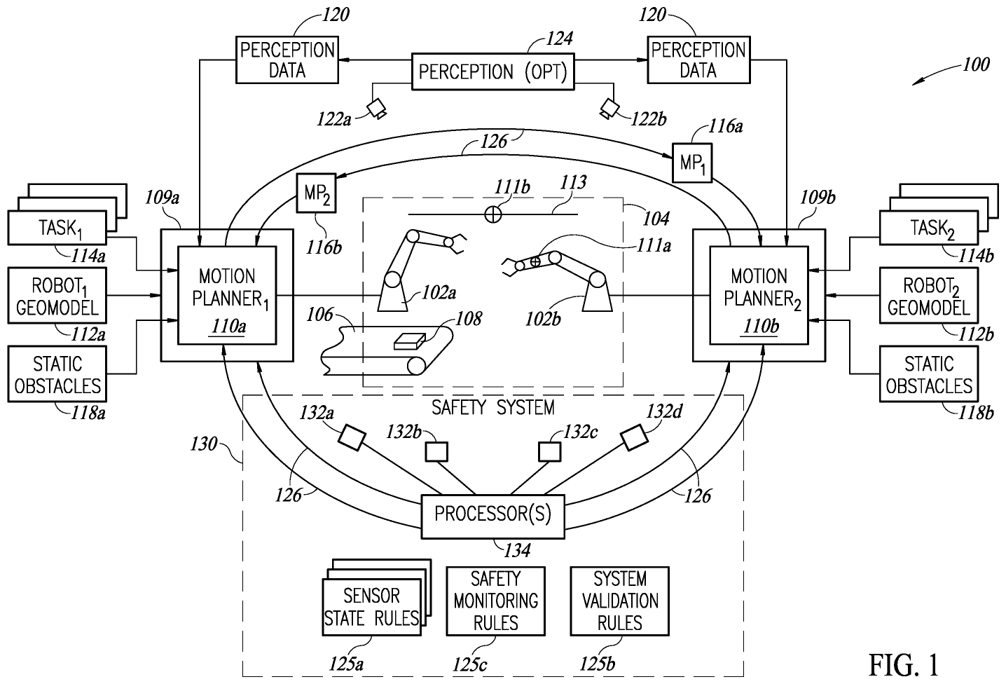

FIG. 1 shows a robotic system 100 which includes one or more robots 102a, 102b (two shown, collectively 102) that operate in an operational environment 104 (also referred to as a workcell) to carry out tasks, according to one illustrated implementation.

The robots 102 can take any of a large variety of forms. Typically, the robots 102 will take the form of, or have, one or more robotic appendages. The robots 102 may include one or more linkages with one or more joints, and actuators (e.g., electric motors, stepper motors, solenoids, pneumatic actuators or hydraulic actuators) coupled and operable to move the linkages in response to control or drive signals. Pneumatic actuators may, for example, include one or more pistons, cylinders, valves, reservoirs of gas, and/or pressure sources (e.g., compressor, blower). Hydraulic actuators may, for example, include one or more pistons, cylinders, valves, reservoirs of fluid (e.g., low compressibility hydraulic fluid), and/or pressure sources (e.g., compressor, blower). The robotic system 100 may employ other forms of robots 102, for example autonomous vehicles, either with or without moveable appendages.

The operational environment 104 typically represents a three-dimensional space in which the robots 102a, 102b may operate and move, although in certain limited implementations the operational environment 104 may represent a two-dimensional space. The operational environment 104 is a volume or area in which at least portions of the robots 102 may overlap in space and time or otherwise collide if motion is not controlled to avoid collision. It is noted that the workcell or operational environment 104 is different from a respective “configuration space” or “C-space” of the robot 102a, 102b.

As explained herein, a robot 102a or portion thereof may constitute an obstacle when considered from a viewpoint of another robot 102b (i.e., when motion planning for another robot 102b). The operational environment 104 may additionally include other obstacles, for example pieces of machinery (e.g., conveyor 106), posts, pillars, walls, ceiling, floor, tables, humans, and/or animals. The operational environment 104 may additionally include one or more work items or work pieces 108 which the robots 102 manipulate as part of performing tasks, for example one or more parcels, packaging, fasteners, tools, items or other objects. In at least some implementations, the operational environment 104 may additionally include one or more fiducials 111a, 111b (only two shown, collectively 111). As described in detail herein, the fiducials 111a, 111b may facilitate determining whether one or more sensors are operating properly. One or more fiducials 111a may be a distinctive portion of a robot 102b or carried by a portion of the robot 102b, and moves with the portion of the robot in a safety certifiable known or knowable manner (e.g., known or discernable trajectory over time, for instance based on joint rotation angles). One or more fiducials 111b may be separate and distinct from the robots 102a, 102b and mounted for movement (e.g., on a track or rail 113) and driven by an actuator (e.g. motor, solenoid) to move in a safety certifiable known or knowable manner (e.g., known or discernable trajectory over time, for instance based on rotational speed of drive shaft of motor captured by a rotary encoder).

The robotic system 100 may include one or more robot control systems 109a, 109b (two shown, collectively 109) which include one or more motion planners, for example a respective motion planner 110a, 110b (two shown, collectively 110) for each of the robots 102a, 102b respectively. In at least some implementations, a single motion planner 110 may be employed to generate motion plans for two, more, or all robots 102. The motion planners 110 are communicatively coupled to control respective ones of the robots 102. The motion planners 110 are also communicatively coupled to receive various types of input, for example including robot geometric models 112a, 112b (also known as kinematic models, collectively 112), tasks 114a, 114b (collectively 114), and motion plans 116a, 116b (collectively 116) or other representations of motions for the other robots 102 operating in the operational environment 104. The robot geometric models 112 define a geometry of a given robot 102, for example in terms of joints, degrees of freedom, dimensions (e.g., length of linkages), and/or in terms of the respective C-space of the robot 102. The conversion of robot geometric models 112 to motion planning graphs may occur before runtime or task execution, performed for example by a processor-based server system (not illustrated in FIG. 1). Alternatively, motion planning graphs may, for example, be generated by one or more processor-based robot control systems 109a, 109b, using any of a variety of techniques. The tasks 114 specify tasks to be performed, for example in terms of end poses, end configurations or end states, and/or intermediate poses, intermediate configurations or intermediate states of the respective robot 102. Poses, configurations or states may, for example, be defined in terms of joint positions and joint angles/rotations (e.g., joint poses, joint coordinates) of the respective robot 102.

The motion planners 110a, 110b are optionally communicatively coupled to receive as input static object data 118a, 118b (collectively 118). The static object data 118 is representative (e.g., size, shape, position, space occupied) of static objects in the workcell or operational environment 104, which may, for instance, be known a priori. Static object may, for example, include one or more of fixed structures in the workcell or operational environment, for instance posts, pillars, walls, ceiling, floor, conveyor 106. Since the robots 102 are operating in a shared workcell or operational environment 104, the static objects will typically be identical for each robot. Thus, in at least some implementations, the static object data 118a, 118b supplied to the motion planners 110 will be identical. In other implementations, the static object data 118a, 118b supplied to the motion planners 110 may differ for each robot, for example based on a position or orientation of the robot 102 in the environment or an environmental perspective of the robot 102. Additionally, as noted above, in some implementations, a single motion planner 110 may generate the motion plans for two or more robots 102.

The motion planners 110 are optionally communicatively coupled to receive as input perception data 120, for example provided by a perception subsystem 124. The perception data 120 is representative of static and/or dynamic objects in the workcell or operational environment 104 that are not known a priori. The perception data 120 may be raw data as sensed via one or more sensors (e.g., two-dimensional or three-dimensional cameras 122a, 122b, time-of-flight cameras, laser scanners, LIDAR, LED-based photoelectric sensors, laser-based sensors, ultrasonic sensors, sonar sensors) and/or as converted to digital representations of obstacles by the perception subsystem 124. Such sensors may take the form of COTS sensors and may, or may not, be employed as part of a safety certified safety system.

The optional perception subsystem 124 may include one or more processors, which may execute one or more machine-readable instructions that cause the perception subsystem 124 to generate a respective discretization of a representation of an environment in which the robots 102 will operate to execute tasks for various different scenarios.

The optional perception sensors (e.g., camera 122a, 122b) provide raw perception information (e.g., point cloud) to perception subsystem 124. The optional perception subsystem 124 may process the raw perception information, and resulting perception data may be provided as a point cloud, an occupancy grid, boxes (e.g., bounding boxes) or other geometric objects, or a stream of voxels (i.e., a “voxel” is an equivalent to a 3D or volumetric pixel) that represent obstacles that are present in the environment. The representation of obstacles may optionally be stored in on-chip memory of any of one or more processors, for instance one or more processors of the optional perception subsystem 124. The perception data 120 may represent which voxels or sub-volumes (e.g., boxes) are occupied in the environment at a current time (e.g., run time). In some implementations, when representing either a robot or another obstacle in the environment, the respective surfaces of the robot or an obstacle (e.g., including other robots) may be represented as either voxels or meshes of polygons (often triangles). In some cases, it is advantageous to represent the objects instead as boxes (rectangular prisms, bounding boxes) or other geometric objects. Due to the fact that objects are not randomly shaped, there may be a significant amount of structure in how the voxels are organized; many voxels in an object are immediately next to each other in 3D space. Thus, representing objects as boxes may require far fewer bits (i.e., may require just the x, y, z Cartesian coordinates for two opposite corners of the box). Also, performing intersection tests for boxes is comparable in complexity to performing intersection tests for voxels.

At least some implementations may combine the outputs of multiple sensors and the sensors may provide a very fine granularity voxelization. However, in order for the motion planner to efficiently perform motion planning, coarser voxels (i.e., “processor voxels”) may be used to represent the environment and a volume in 3D space swept by the robot 102 or portion thereof when making transitions between various states, configurations or poses. Thus, the optional perception subsystem 124 may transform the output of the sensors (e.g., camera 122a, 122b) accordingly. For example, the output of the camera 122a, 122b may use 10 bits of precision on each axis, so each voxel originating directly from the camera 122a, 122b has a 30-bit ID, and there are 230 sensor voxels. The robot control system 109a, 109b may use 6 bits of precision on each axis for an 18-bit processor voxel ID, and there would be 218 processor voxels. Thus, there could, for example, be 212 sensor voxels per processor voxel. At runtime, if the system determines any of the sensor voxels within a processor voxel is occupied, the robot control system 109a, 109b considers the processor voxel to be occupied and generates the occupancy grid accordingly.

The robotic system 100 may include one or more processor-based workcell safety systems 130 (one shown) which include a plurality of sensors, for example a first sensor 132a, second sensor 132b, third sensor 132c, and fourth sensor 132d (only four shown, collectively 132), and one or more processors 134 communicatively coupled to the sensors 132 of the safety system 130.

The sensors 132 are positioned and oriented to collectively sense or monitor a majority or even all of the operational environment 104. Preferably, at least pairs of the sensors 132 overlap in coverage of various portions of the operational environment, facilitating safety certified operation via application of FMEA approaches or techniques. While four sensors 132 are illustrated, a smaller or even more likely larger number of sensors 132 may be employed. The total number of sensors 132 employed by the safety systems 130 will typically depend in part of the size and configuration of the operational environment, the type of sensors 132, the level of safety desired or specified, and/or the level or extent of occlusions considered acceptable. As explained herein, the sensors 132 may advantageously take the form of COTS sensors, yet through the application of FMEA approaches or techniques, at least some of which are described herein, the overall processor-based workcell safety system 130 is safety certified.

The sensors 132 preferably comprise a set of heterogeneous sensors.

Heterogeneous sensors 132 may, for example, take the form of a first sensor having a first operational modality, a second sensor having a second operational modality. The second operational modality may advantageously be different from the first operational modality. In such implementations, the processor-based system advantageously receives information from the first sensor in a first modality format and receives information from the second sensor in a second modality format, the second modality format different from the first modality format. For instance, the first sensor may take the form of an image sensor and the first modality format a digital image. Also for instance, the second sensor may take the form of a laser scanner, a passive infrared (PIR) motion sensor, ultrasonic, sonar, LIDAR, or a heat sensor and the second modality format is an analog signal or a digital signal, neither one of which is in a digital image format. In any given implementation there may be a third sensor, fourth sensor or even more sensors with their own respective operational modalities, increasing diversity and heterogeneity.

Heterogeneous sensors 132 may, for example, take the form of a first sensor having a first field of view of the operational environment and a second sensor having a second field of view of the operational environment, the second field of view different from the first field of view. In such implementations, the processor-based system advantageously receives information from the first sensor with the first field of view and receives information from the second sensor with the second field of view. In any given implementation there may be a third sensor, fourth sensor or even more sensors with their own respective fields of view, increasing diversity and heterogeneity. In some instances, the fields of view of two or more sensors may partially overlap or completely overlap, some fields of view of two or more sensors being coterminous in all respects.

Heterogeneous sensors 132 may, for example, take the form of a first sensor having a first make (i.e., manufacturer) and model of sensor, the second sensor having a second make and model of sensor, at least one of the second make or model of the second sensor different than a respective one of the first make and model of the first sensor. In such implementations, the processor-based system advantageously receives information from the first sensor in a first format that may be specific to the first make and/or model of sensor and receives information from the second sensor in a second format that may be specific to the second make and/or model of sensor. In any given implementation there may be a third sensor, fourth sensor or even more sensors with their own respective makes and models, increasing diversity and heterogeneity.

Heterogeneous sensors may, for example, take the form of a first sensor having a first sampling rate, and a second sensor having a second sampling rate, the second sampling rate different from the first sampling rate. In such implementations, the processor-based system advantageously receives information from the first sensor captured at the first sampling rate and receives information from the second sensor captured at the second sampling rate. In any given implementation there may be a third sensor, fourth sensor or even more sensors with their own respective sampling rates, increasing diversity and heterogeneity.

Any one or more combinations of heterogeneous sensors may be employed. In general, increasing the heterogeneity of the set of sensors can advantageously be used to achieve safety certification of the overall safety system, although increasing the heterogeneity of the set of sensors may disadvantageously increase maintenance costs so would typically be avoided.

The sensors 132 may be separate and distinct from the cameras 122a, 122b of the perception subsystem 124. Alternatively, one or more of the sensors 132 may be part of the perception subsystem 124. The sensors 132 may take any of a large variety of forms capable of sensing objects in an operational environment 104, and in particular of sensing an operational environment 104 to detect the presence, position and/or movement or trajectory of one or more humans in the operational environment 104. The sensors 132 may, in a non-limiting example, take the form of two-dimensional digital cameras, three-dimensional digital cameras, time-of-flight cameras, laser scanners, laser-based sensors, ultrasound sensors, sonar, passive-infrared sensors, LIDAR, and/or heat sensors. As used herein, the term sensor includes the sensor or transducer that detects physical characteristics of the operational environment 104, as well as any transducer or other source of energy associated with such sensor, for example light emitting diodes, other light sources, lasers and laser diodes, speakers, haptic engines, sources of ultrasound energy, etc.

While not illustrated, some implementations may include additional types of sensors that detect when a human has entered an operational environment; for example a radio frequency identification (RFID) interrogation system that detects RFID transponders worn by humans, a laser scanner, a pressure sensor, a passive infrared (PIR) motion detector that detect the presence of a human in the workcell, but not necessarily a position or location of the human in the workcell.

The one or more processors 134 and other components (e.g., communications ports, radios, analog-to-digital converters) of the processor-based workcell safety system 130 are communicatively coupled to the sensors 132 to receive sensor data therefrom. The processor(s) 134 of the processor-based workcell safety system 130 executes logic, for example stored as processor-executable instructions in non-transitory processor-readable media (e.g., read only memory, random access memory, Flash memory, Solid State Drive, magnetic hard disk drive).

For example, the processor-based workcell safety system 130 may store one or more sets of sensor state rules 125a on at least one non-transitory processor-readable media. The sensor state rules 125a specify rules, operational conditions, values or ranges of values of various parameters and/or other criteria for respective sensors 132 or types of sensors. The processor-based workcell safety system 130 may apply the sensor state rules 125a to assess or otherwise determine an operational state of any given sensor 132, that is whether the respective sensor 132 is operating within normal or acceptable bounds (i.e., no fault condition, operational state), or to identify a faulty or potentially faulty sensor 132 or other unacceptable condition (i.e., fault condition, inoperable state). The assessment may assess one, two or more operational conditions for each of the sensors 132. The sensor operational state may be based on an assessment of any one or more of: ON state or OFF state; the sensor providing sensor information; the sensor providing sensor information at nominal sampling rate of the sensor; the sensor not in a stuck state (i.e., sensor information provided by the sensor is changing; is changing in an expected way relative to a known predefined environmental condition; and/or is changing in a way that is consistent with changes sensed by other sensor(s), e.g., movement of another robot or other fiduciary). The assessments may, for example assess the operational state of a given sensor by comparison between two or more of the sensors 132 (e.g., comparing output of two or more sensors 132), examples of which are described herein. As an example, each sensor 132 may be associated with a respective sampling rate. The sensor state rules 125a may define a respective acceptable sampling range or a percentage of sampling rate error that is considered to be acceptable, or conversely similar values that are considered unacceptable. Also as an example, the sensor state rules 125a may define a respective amount of time that a sensor 132 may be stuck or a frequency for confirming that the sensor 132 is not stuck, that is considered acceptable, or conversely similar values that are considered not acceptable. The operational conditions or assessment of the operational state of sensors may indicate whether one or more sensors 132 are operating as expected and/or operating within a defined set of performance parameters or conditions and thus individual sensors can be relied on for providing a safe workcell or operational environment 104 or whether a faulty or inoperable state or a potentially faulty or inoperable state exists.

The sensor state rules 125a may be stored by, or searchable by, sensor type or even by individual sensor identity.

Also for example, the processor-based workcell safety system 130 may store one or more sets of system validation rules 125b on at least one non-transitory processor-readable media. The system validation rules 125b specify rules, operational conditions, values of parameters and/or other criteria used to validate operational status of the processor-based workcell safety system 130. Validation may be based, for instance, on the determined operational states of the sensors 132. The system validation rules 125b may, for instance, specify rules for select sensors 132 and/or one or more select groups of sensors 132 (e.g., all sensors must be operational; sensors identified as necessary must be operational while other sensors may or may not be operational; a majority of sensors of a set of sensors must be in agreement). The processor-based workcell safety system 130 may assess or otherwise apply the system validation rules 125b to determine whether there are sufficient sensors 132 that are operating within normal or acceptable bounds to rely on the safety system 130 for ensuring safety certified operation. When there are sufficient sensors 132 that are operating within normal or acceptable bounds to rely on the safety system 130 to ensure safety certified operation, the processor-based workcell safety system 130 may identify or indicate the existence of a non-anomalous system status. Conversely, where there are insufficient sensors 132 that are operating within normal or acceptable bounds to rely on the safety system 130 to ensure safety certified operation, the processor-based workcell safety system 130 may identify or indicate the existence of an anomalous system status.

As also explained herein, the processor-based workcell safety system 130 may optionally determine whether an outcome of a system validation indicates an anomalous system status or a non-anomalous system status exists for the processor-based workcell safety system 130 that would render the overall processor-based workcell safety system 130 unreliable. Such may be based at least in part of the assessment of the first, the second sensors, and possibly more sensors. The system status for the processor-based workcell safety system 130 can be defined via a set of system validation rules 125b that specify how many and/or which sensors 132 may be considered operative or reliable for a non-anomalous state to exist or conversely specify how many and/or which sensors 132 may be considered inoperative or not reliable for an anomalous system status to exist. The system validation rules 125b may specify that a defined error or fault indication or operational state in any single specific one of the sensors 132 (i.e., a necessary or required sensor) constitutes an anomalous system status for the processor-based workcell safety system 130. The system validation rules 125b may specify that a defined error or fault indication or operational state in a set of two or more specific sensors 132 constitutes an anomalous system status for the processor-based workcell safety system 130. For instance, detection of a fault condition or faulty operational state in any single one of a set of sensors, or detection of a fault condition or faulty operational state in all of the sensors of a set of sensors, or detection of a fault condition or faulty operational state in a majority of sensors of a set of sensors constitutes an anomalous system status for the processor-based workcell safety system 130. Alternatively, the system validation rules 125b may define an anomalous system status for the processor-based workcell safety system 130 to exist when there is inconsistency between a majority of sensors 132. In some implementations, where there is consistency between a majority of sensors 132, the at least one processor may determine that the sensors 132 are sufficiently reliable to provide safe operation within the operational environment or some portion thereof.

Also for example, the processor-based workcell safety system 130 may store one or more sets of safety monitoring rules 125c on at least one non-transitory processor-readable media. The safety monitoring rules 125c specify rules, conditions, values of parameters and/or other criteria used to assess the operational environment for violations of specified safety criteria. For example, the safety monitoring rules 125c may specify rules or criteria that requires a specific condition to be maintained between a robot or portion thereof and an object that is a human or which might be a human. For instance, the safety monitoring rules 125c may specify that there be at least one defined unit of measurement (e.g., region of a grid) between the object (e.g., human) and a portion of a robot or path or trajectory of a robot, for instance over a time it will take the robot to move along the path or trajectory. The processor-based workcell safety system 130 may assess sensor data provided by one or more of the sensors 132 to determine a position of an object, and/or assess whether the object is or many be a human. The processor-based workcell safety system 130 may assess sensor data provided by one or more of the sensors 132, sensor data provided by the perception subsystem 124, and/or information (e.g., joint angles) from the robot control systems 109a, 109b or from the robots 102a, 102b themselves to determine a position and orientation and/or a trajectory of the robots 102a, 102b over a given time. The processor-based workcell safety system 130 may determine whether the position, path or trajectory of the human and the position, path or trajectory of the robot(s) 102a, 102b will violate one or more of the safety monitoring rules 125c. In response to detecting a violation of the safety monitoring rules 125c, the processor-based workcell safety system 130 may provide one or more signals that cause a stoppage, slowdown, introduction of a precautionary occlusion, or otherwise inhibit operation of one or more of the robots 102a, 102b.

Various communicative paths are illustrated in FIG. 1 as arrows. The communicative paths may for example take the form of one or more wired communications paths (e.g., electrical conductors, signal buses, or optical fiber) and/or one or more wireless communications paths (e.g., via RF or microwave radios and antennas, infrared transceivers). Notably, each of the motion planners 110a, 110b is communicatively coupled to one another, either directly or indirectly, to provide the motion plan for a respective one of the robots 102a, 102b to the other ones of the motion planners 110a, 110b. For example, the motion planners 110a, 110b may be communicatively coupled to one another via a network infrastructure, for instance a non-proprietary network infrastructure (e.g., Ethernet network infrastructure) 126. Also notably, the processor-based workcell safety system 130 is optionally communicatively coupled to the robot control systems 109a, 109b to provide signals thereto. For instance, the processor-based workcell safety system 130 may provide signals to stop or slow movement of one or more robots 102, for example in response to a determination that an anomalous system status exists. Also for instance, the processor-based workcell safety system 130 may provide signals, for example to the robot control systems 109a, 109b, to cause the motion planners 110a, 110b to treat one or more areas or regions of the operational environment as occluded. For example, areas or regions monitored by one or more sensor(s) may be identified as occluded in response to determining that the respective sensor(s) 132 is operating outside of a set of expected conditions (e.g., faulty operational state of sensor(s)). Also for instance, the processor-based workcell safety system 130 may provide the robot control systems 109a, 109b and/or the motion planners 110a, 110b access to one or more of sets of safety monitoring rules 125c. Such may allow the robot control portion (e.g., robot control systems 109a, 109b, motion planner 110a, 110b) of the robotic system 100 to advantageously take into account the configuration of the safety system, and in particular the conditions that will trigger an inhibition of robot operation, when developing and/or executing motion plans, as described herein. Thus, while the functional portion of the robotic system 100 can generally be configured independently of the processor-based workcell safety system 130, the robot control systems 109a, 109b can advantageously take into account the operation of the processor-based workcell safety system 130, reducing stoppages, slowdowns and/or the use of precautionary occlusions.

The term “environment” is used to refer to a current workcell of a robot, which is an operational environment where one, two or more robots operate in the same workspace. The environment may include obstacles and/or work pieces (i.e., items with which the robots are to interact or act on or act with). The term “task” is used to refer to a robotic task in which a robot transitions from a pose A to a pose B without colliding with obstacles in its environment. The task may perhaps involve the grasping or un-grasping of an item, moving or dropping an item, rotating an item, or retrieving or placing an item. The transition from pose A to pose B may optionally include transitioning between one or more intermediary poses. The term “scenario” is used to refer to a class of environment/task pairs. For example, a scenario could be “pick-and-place tasks in an environment with a 3-foot table or conveyor and between x and y obstacles with sizes and shapes in a given range.” There may be many different task/environment pairs that fit into such criteria, depending on the locations of goals and the sizes and shapes of obstacles.

The motion planners 110 are operable to dynamically produce motion plans 116 to cause the robots 102 to carry out tasks in an environment, while taking into account the planned motions (e.g., as represented by respective motion plans 116 or resulting swept volumes) of the other ones of the robots 102 and/or optionally taking into account the rules and conditions employed by the processor-based workcell safety system 130. The motion planners 110 may optionally take into account representations of a priori static objects represented by static object data 118 and/or perception data 120 when producing motion plans 116. Optionally, the motion planners 110 may take into account the safety monitoring rules 125c implemented by the processor-based workcell safety system 130 when generating motion plans. Optionally, the motion planners 110 may take into account a state of motion of other robots 102 at a given time, for instance whether or not another robot 102 has completed a given motion or task, and allowing a recalculation of a motion plan based on a motion or task of one of the other robots being completed, thus making available a previously excluded path or trajectory to choose from. Optionally, the motion planners 110 may take into account an operational condition of the robots 102, for instance an occurrence or detection of a failure condition, an occurrence or detection of a blocked state, and/or an occurrence or detection of a request to expedite or alternatively delay or skip a motion-planning request.

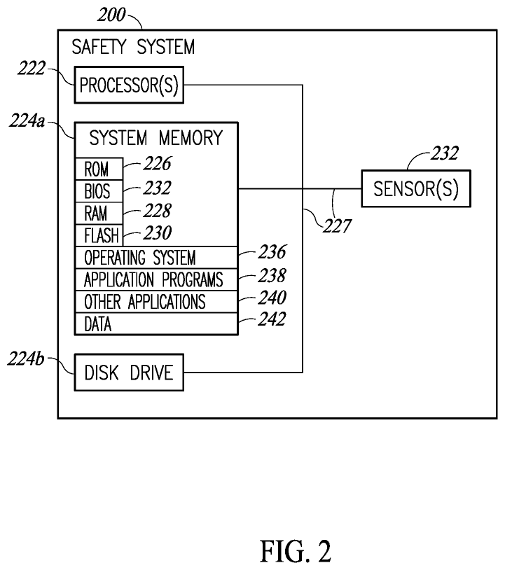

FIG. 2 shows a processor-based workcell safety system 200, according to one illustrated implementation. The processor-based workcell safety system 200 may implement the processor-based workcell safety system 130 (FIG. 1).

The processor-based workcell safety system 200 may comprise a number of sensors 232, preferably a set of heterogeneous sensors, one or more processor(s) 222, and one or more associated non-transitory computer- or processor-readable storage media for example system memory 224a, disk drives 224b, and/or memory or registers (not shown) of the processors 222. The non-transitory computer- or processor-readable storage media are communicatively coupled to the processor(s) 222a via one or more communications channels, such as system bus 227. The system bus 227 can employ any known bus structures or architectures, including a memory bus with memory controller, a peripheral bus, and/or a local bus. One or more of such components may also, or instead, be in communication with each other via one or more other communications channels, for example, one or more parallel cables, serial cables, or wireless network channels capable of high speed communications, for instance, Universal Serial Bus (“USB”) 3.0, Peripheral Component Interconnect Express (PCIe) or via Thunderbolt®.

As noted, the processor-based workcell safety system 200 may include one or more processor(s) 222, (i.e., circuitry), non-transitory storage media, and system bus 227 that couples various system components. The processors 222 may be any logic processing unit, such as one or more central processing units (CPUs), digital signal processors (DSPs), graphics processing units (GPUs), field programmable gate arrays (FPGAs), application-specific integrated circuits (ASICs), programmable logic controllers (PLCs), etc. The system memory 224a may include read-only memory (“ROM”) 226, random access memory (“RAM”) 228 FLASH memory 230, EEPROM (not shown). A basic input/output system (“BIOS”) 232, which can form part of the ROM 226, contains basic routines that help transfer information between elements within the processor-based workcell safety system 200, such as during start-up.

The disk drive 224b may be, for example, a hard disk drive for reading from and writing to a magnetic disk, a solid state (e.g., flash memory) drive for reading from and writing to solid-state memory, and/or an optical disk drive for reading from and writing to removable optical disks. The processor-based workcell safety system 200 may also include any combination of such drives in various different embodiments. The disk drive 224b may communicate with the processor(s) 222 via the system bus 227. The disk drive(s) 224b may include interfaces or controllers (not shown) coupled between such drives and the system bus 227, as is known by those skilled in the relevant art. The disk drive 224b and its associated computer-readable media provide nonvolatile storage of computer- or processor readable and/or executable instructions, data structures, program modules and other data for the processor-based workcell safety system 200. Those skilled in the relevant art will appreciate that other types of computer-readable media that can store data accessible by a computer may be employed, such as WORM drives, RAID drives, magnetic cassettes, digital video disks (“DVD”), Bernoulli cartridges, RAMs, ROMs, smart cards, etc.

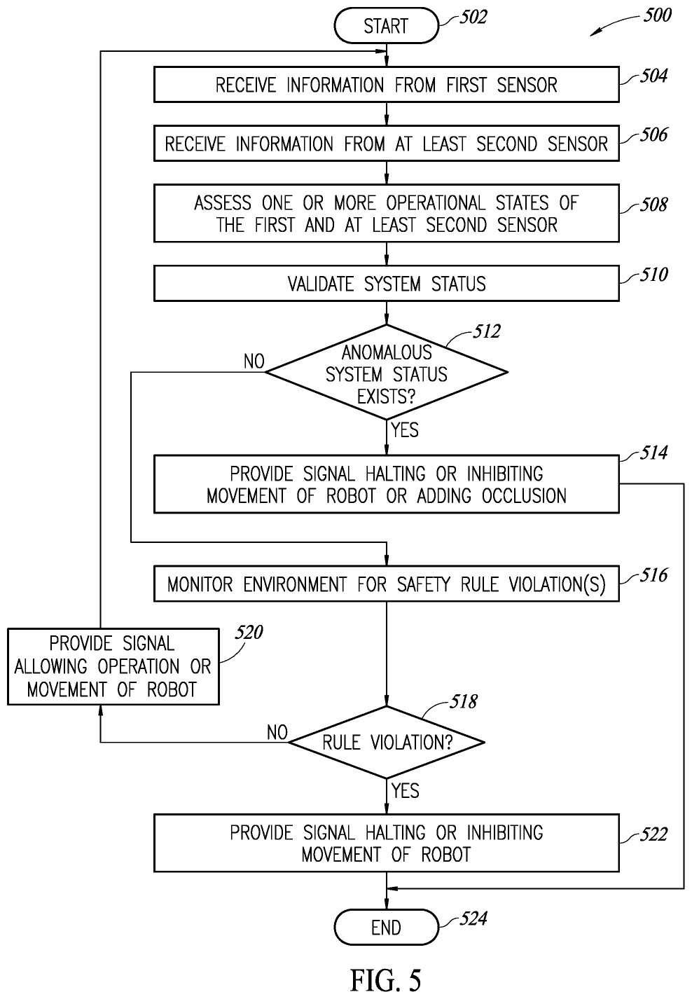

Executable instructions and data can be stored in the system memory 224a, for example an operating system 236, one or more application programs 238, other programs or modules 240 and data 242. Application programs 238 may include processor-executable instructions that cause the processor(s) 222 to perform one or more of: assessing sensor operational states based at least in part on sensor state rules 125a (FIG. 1), assessing a system operational status based at least in part on system validation rules 125b (FIG. 1) to determine whether a non-anomalous system status exists or an anomalous system status exists for the processor-based workcell safety system 200 based on the sensor states of specific sensors 232 and/or groups or sets of sensors 232, and to perform safety monitoring of an operational environment based at least in part on safety monitoring rules 125c (FIG. 1). The processor(s) 222 may execute instructions that execute the various algorithms set out here, for example those of methods 500, 600, 700, and 800 (FIGS. 5, 6, 7 and 8, respectively). Application programs 238 may additionally include one or more machine-readable and machine-executable instructions that cause the processor(s) 222 to perform other operations, for instance optionally handling sensor data captured via sensors 232. Application programs 238 may additionally include one or more machine-executable instructions that cause the processor(s) 222 to perform various other methods described herein and in the references incorporated herein by reference.

Data 242 may, for example, include one or more sets of sensor state rules 125a (FIG. 1) stored on at least one non-transitory processor-readable media. Data 242 may, for example, include one or more sets of system validation rules 125b (FIG. 1) on at least one non-transitory processor-readable media. Data 242 may, for example, include one or more sets of safety monitoring rules 125c (FIG. 1) on at least one non-transitory processor-readable media.

In various implementations, one or more of the operations described above may be performed by one or more remote processing devices or computers, which are linked through a communications network via a network interface.

While shown in FIG. 2 as being stored in the system memory 224a, the operating system 236, application programs 238, other programs/modules 240, and program data 242 can be stored on other non-transitory computer- or processor-readable media, for example disk drive(s) 224b.

The processor(s) 222 may be, or may include, any logic processing units, such as one or more central processing units (CPUs), digital signal processors (DSPs), graphics processing units (GPUs), application-specific integrated circuits (ASICs), field programmable gate arrays (FPGAs), programmable logic controllers (PLCs), etc. Non-limiting examples of commercially available computer systems include, but are not limited to, the Celeron, Core, Core 2, Itanium, and Xeon families of microprocessors offered by Intel® Corporation, U.S.A.; the K8, K10, Bulldozer, and Bobcat series microprocessors offered by Advanced Micro Devices, U.S.A.; the A5, A6, and A7 series microprocessors offered by Apple Computer, U.S.A.; the Snapdragon series microprocessors offered by Qualcomm, Inc., U.S.A.; and the SPARC series microprocessors offered by Oracle Corp., U.S.A. The construction and operation of the various structure shown in FIG. 2 may implement or employ structures, techniques and algorithms described in or similar to those described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; International Patent Application Publication No. WO 2016/122840, filed Jan. 5, 2016, entitled “SPECIALIZED ROBOT MOTION PLANNING HARDWARE AND METHODS OF MAKING AND USING SAME”; and/or U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”.

Although not required, many of the implementations will be described in the general context of computer-executable instructions, such as program application modules, objects, or macros stored on computer- or processor-readable media and executed by one or more computer or processors that can perform obstacle representation, collision assessments, and other motion planning operations.

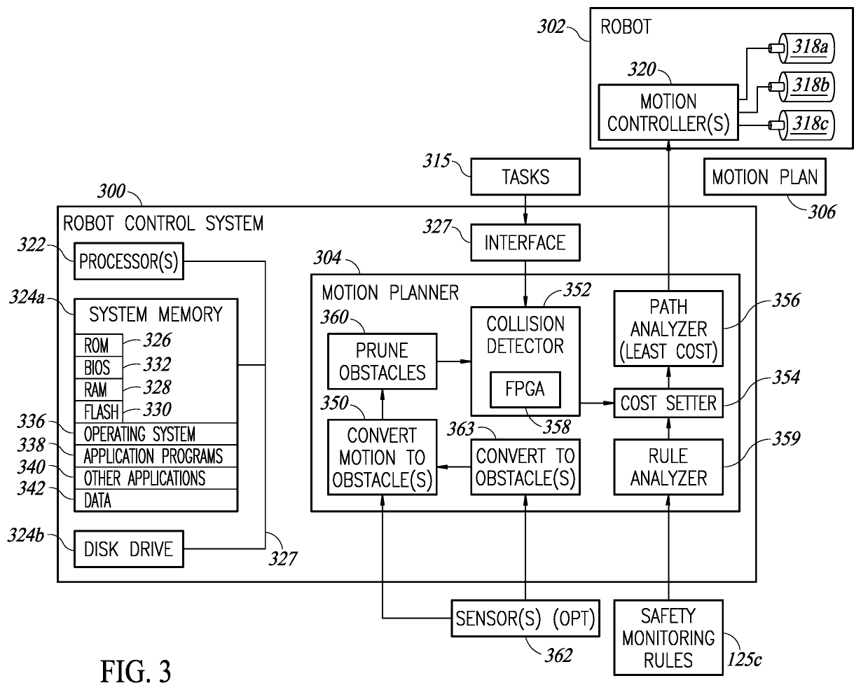

FIG. 3 shows a first robot control system 300 and a first robot 302, according to at least illustrated implementation. The first robot control system 300 includes a first motion planner 304 that generates first motion plans 306 to control operation of the first robot 302.

Likewise, the other motion planners of the other robot control systems generate other motion plans to control operation of other robots (not illustrated in FIG. 3).

The robot control system(s) 300 may be communicatively coupled, for example via at least one communications channel (e.g., transmitter, receiver, transceiver, radio, router, Ethernet), to receive motion planning graphs and/or swept volume representations from one or more sources of motion planning graphs and/or swept volume representations. The source(s) of motion planning graphs and/or swept volumes may be separate and distinct from the motion planners 304, according to one illustrated implementation. The source(s) of motion planning graphs and/or swept volumes may, for example, be one or more processor-based computing systems (e.g., server computers), which may be operated or controlled by respective manufacturers of the robots 302 or by some other entity. The motion planning graphs may each include a set of nodes which represent states, configurations or poses of the respective robot, and a set of edges which couple nodes of respective pairs of nodes, and which represent legal or valid transitions between the states, configurations or poses. States, configurations or poses may, for example, represent sets of joint positions, orientations, poses, or coordinates for each of the joints of the respective robot 302. Thus, each node may represent a pose of a robot 302 or portion thereof as completely defined by the poses of the joints comprising the robot 302. The motion planning graphs may be determined, set up, or defined prior to a runtime (i.e., defined prior to performance of tasks), for example during a pre-runtime or configuration time. The swept volumes represent respective volumes that a robot 302 or portion thereof would occupy when executing a motion or transition that corresponds to a respective edge of the motion planning graph. The swept volumes may be represented in any of a variety of forms, for example as voxels, a Euclidean distance field, a hierarchy of geometric objects. This advantageously permits some of the most computationally intensive work to be performed before runtime, when responsiveness is not a particular concern.

The robot control system(s) 300 may optionally be communicatively coupled, for example via at least one communications channel (e.g., transmitter, receiver, transceiver, radio, router, Ethernet), to receive signals and/or data from the processor-based workcell safety system 130 (FIG. 1) or processor-based workcell safety system 200 (FIG. 2), for example including signals to stop robot operation, to slow robot operation, to indicate an area or region as occluded, and/or to access safety monitoring rules 125c (FIG. 1). Alternatively, safety monitoring rules 125c (FIG. 1) may optionally be stored at the robot control system(s) 300.

Each robot 302 may include a set of links, joints, end-of-arm tools or end effectors, and/or actuators 318a, 318b, 318c (three, shown, collectively 318) operable to move the links about the joints. Each robot 302 may include one or more motion controllers (e.g., motor controllers) 320 (only one shown) that receive control signals, for instance in the form of motion plans 306, and that provide drive signals to drive the actuators 318.

There may be a respective robot control system 300 for each robot 302, or alternatively one robot control system 300 may perform the motion planning for two or more robots 302. One robot control system 300 will be described in detail for illustrative purposes. Those of skill in the art will recognize that the description can be applied to similar or even identical additional instances of other robot control systems.

The robot control system 300 may comprise one or more processor(s) 322, and one or more associated non-transitory computer- or processor-readable storage media for example system memory 324a, disk drives 324b, and/or memory or registers (not shown) of the processors 322. The non-transitory computer- or processor-readable storage media are communicatively coupled to the processor(s) 322a via one or more communications channels, such as system bus 327. The system bus 327 can employ any known bus structures or architectures, including a memory bus with memory controller, a peripheral bus, and/or a local bus. One or more of such components may also, or instead, be in communication with each other via one or more other communications channels, for example, one or more parallel cables, serial cables, or wireless network channels capable of high speed communications, for instance, Universal Serial Bus (“USB”) 3.0, Peripheral Component Interconnect Express (PCIe) or via Thunderbolt®.

The robot control system 300 may also be communicably coupled to one or more remote computer systems, e.g., server computer (e.g. source of motion planning graphs), desktop computer, laptop computer, ultraportable computer, tablet computer, smartphone, wearable computer and/or sensors (not illustrated in FIG. 3), that are directly communicably coupled or indirectly communicably coupled to the various components of the robot control system 300, for example via a network interface (not shown). Remote computing systems (e.g., server computer (e.g., source of motion planning graphs)) may be used to program, configure, control or otherwise interface with or input data (e.g., motion planning graphs, swept volumes, task specifications 315) to the robot control system 300 and various components within the robot control system 300. Such a connection may be through one or more communications channels, for example, one or more wide area networks (WANs), for instance, Ethernet, or the Internet, using Internet protocols. As noted above, pre-runtime calculations (e.g., generation of the family of motion planning graphs) may be performed by a system that is separate from the robot control system 300 or robot 302, while runtime calculations may be performed by the processor(s) 322 of the robot control system 300, which in some implementation may be on-board the robot 302.

As noted, the robot control system 300 may include one or more processor(s) 322, (i.e., circuitry), non-transitory storage media (e.g., system memory 324a, disk drive(s) 324b), and system bus 327 that couples various system components. The processors 322 may be any logic processing unit, such as one or more central processing units (CPUs), digital signal processors (DSPs), graphics processing units (GPUs), field programmable gate arrays (FPGAs), application-specific integrated circuits (ASICs), programmable logic controllers (PLCs), etc. The system memory 324a may include read-only memory (“ROM”) 326, random access memory (“RAM”) 328 FLASH memory 330, EEPROM (not shown). A basic input/output system (“BIOS”) 332, which can form part of the ROM 326, contains basic routines that help transfer information between elements within the robot control system 300, such as during start-up.

The drive 324b may be, for example, a hard disk drive for reading from and writing to a magnetic disk, a solid state (e.g., flash memory) drive for reading from and writing to solid-state memory, and/or an optical disk drive for reading from and writing to removable optical disks. The robot control system 300 may also include any combination of such drives in various different embodiments. The drive 324b may communicate with the processor(s) 322 via the system bus 327. The drive(s) 324b may include interfaces or controllers (not shown) coupled between such drives and the system bus 327, as is known by those skilled in the relevant art. The drive 324b and its associated computer-readable media provide nonvolatile storage of computer- or processor readable and/or executable instructions, data structures, program modules and other data for the robot control system 300. Those skilled in the relevant art will appreciate that other types of computer-readable media that can store data accessible by a computer may be employed, such as WORM drives, RAID drives, magnetic cassettes, digital video disks (“DVD”), Bernoulli cartridges, RAMs, ROMs, smart cards, etc.

Executable instructions and data can be stored in the system memory 324a, for example an operating system 336, one or more application programs 338, other programs or modules 340 and program data 342. Application programs 338 may include processor-executable instructions that cause the processor(s) 322 to perform one or more of: generating discretized representations of the environment in which the robot 302 will operate, including obstacles and/or target objects or work pieces in the environment where planned motions of other robots may be represented as obstacles; generating motion plans or road maps including calling for or otherwise obtaining results of a collision assessment, setting cost values for edges in a motion planning graph, and evaluating available paths in the motion planning graph; optionally storing the determined plurality of motion plans or road maps; and/or optionally identifying situations which would likely cause the processor-based workcell safety system 130, 200 to trigger and associating a cost with corresponding transitions in order to defer such, thereby potentially avoiding a stoppage, slowdown, or introduction of a precautionary occlusion. The motion plan construction (e.g., collision detection or assessment, updating costs of edges in motion planning graphs based on collision detection or assessment and/or rules and conditions that trigger the processor-based workcell safety system, and path search or evaluation) can be executed as described herein and in the references incorporated herein by reference. The collision detection or assessment may perform collision detection or assessment using various structures and techniques described elsewhere herein. Application programs 338 may additionally include one or more machine-readable and machine-executable instructions that cause the processor(s) 322 to perform other operations, for instance optionally handling perception data (captured via sensors). Application programs 338 may additionally include one or more machine-executable instructions that cause the processor(s) 322 to perform various other methods described herein and in the references incorporated herein by reference.

Optionally, safety monitoring rules 125c (FIG. 1) may be stored at the robot control system(s) 300, for example in the system memory 324a.

In various embodiments, one or more of the operations described above may be performed by one or more remote processing devices or computers, which are linked through a communications network (e.g., network) via network interface.

While shown in FIG. 3 as being stored in the system memory 324a, the operating system 336, application programs 338, other programs/modules 340, and program data 342 can be stored on other non-transitory computer- or processor-readable media, for example drive(s) 324b.

The motion planner 304 of the robot control system 300 may include dedicated motion planner hardware or may be implemented, in all or in part, via the processor(s) 322 and processor-executable instructions stored in the system memory 324a and/or drive 324b.

The motion planner 304 may include or implement a motion converter 350, a collision detector 352, a rule analyzer 359, a cost setter 354, and a path analyzer 356.

The motion converter 350 converts motions of other ones of the robots into representations of obstacles. The motion converter 350 receives the motion plans or other representations of motion from other motion planners. The motion converter 350 then determines an area or volume corresponding to the motion(s). For example, the motion converter can convert the motion to a corresponding swept volume, that is a volume swept by the corresponding robot or portion thereof in moving or transitioning between poses as represented by the motion plan. Advantageously, the motion planner 304 may simply queue the obstacles (e.g., swept volumes), and may not need to determine, track or indicate a time for the corresponding motion or swept volume. While described as a motion converter 350 for a given robot 302 converting the motions of other robots to obstacles, in some implementations the other robots 302b may provide the obstacle representation (e.g., swept volume) of a particular motion to the given robot 302.

The collision detector 352 performs collision detection or analysis, determining whether a transition or motion of a given robot 302 or portion thereof will result in a collision with an obstacle. As noted, the motions of other robots may advantageously be represented as obstacles. Thus, the collision detector 352 can determine whether a motion of one robot will result in collision with another robot that moves through the workcell or operational environment 104.

In some implementations, collision detector 352 implements software based collision detection or assessment, for example performing a bounding box-bounding box collision assessment or assessing based on a hierarchy of geometric (e.g., spheres) representation of the volume swept by the robots 302 or portions thereof during movement. In some implementations, the collision detector 352 implements hardware based collision detection or assessment, for example employing a set of dedicated hardware logic circuits to represent obstacles and streaming representations of motions through the dedicated hardware logic circuits. In hardware based collision detection or assessment, the collision detector can employ one or more configurable arrays of circuits, for example one or more FPGAs 358, and may optionally produce Boolean collision assessments.

The rule analyzer 359 determines or assesses a likelihood or probability that a motion or transition (represented by an edge in a graph) will result in the processor-based workcell safety system triggering a stoppage, slowdown or precautionary occlusion or other inhibition of robot operation. For example, the rule analyzer 359 may evaluate or simulate a motion plan or portion thereof (e.g., an edge) of one or more robots, determining whether any transitions will violate a safety rule (e.g., result in the robot(s) or portion thereof passing too close to a human as defined by the safety monitoring rules 125c (FIG. 1) implemented by the processor-based workcell safety system). For example, the rule analyzer 359 may evaluate or simulate a position and/or path or trajectory of an object (e.g., human) or portion thereof, determining whether any position or movements of the object will violate a safety rule (e.g., result in a human or portion thereof passing too close to a robot or robots as defined by the safety monitoring rules 125c (FIG. 1) implemented by the processor-based workcell safety system). For instance, where the processor-based workcell safety system employs a laser scanner that sections a portion of the operational environment into a grid, and a rule enforced by the processor-based workcell safety causes a stoppage, slowdown or precautionary occlusion when a human is within one grid position of the position of a portion of the robot, the rule analyzer 359 may identify transitions that would bring a portion of the robot within one grid of the position of a human, or predicted position of a human, so that weights associated with edges corresponding to those identified transitions can be adjusted (e.g., increased).

The cost setter 354 can set or adjust a cost of edges in a motion planning graph, based at least in part on the collision detection or assessment, and optionally based on an analysis by the rule analyzer 359 of the rules and conditions applied by the processor-based workcell safety system 130 (FIG. 1), 200 (FIG. 2). For example, the cost setter 354 can set a relatively high cost value for edges that represent transitions between states or motions between poses that result or would likely result in collision, and/or which would likely cause the processor-based workcell safety system 130, 200 to trigger, thereby potentially avoiding a stoppage, slowdown, or introduction of a precautionary occlusion. Also for example, the cost setter 354 can set a relatively low cost value for edges that represent transitions between states or motions between poses that do not result or would likely not result in collision and/or which would not likely cause the processor-based workcell safety system 130, 200 to trigger, thereby potentially avoiding a stoppage, slowdown, or introduction of a precautionary occlusion. Setting cost can include setting a cost value that is logically associated with a corresponding edge via some data structure (e.g., field, pointer, table).

The path analyzer 356 may determine a path (e.g., optimal or optimized) using the motion planning graph with the cost values. For example, the path analyzer 356 may constitute a least cost path optimizer that determines a lowest or relatively low cost path between two states, configurations or poses, the states, configurations or poses which are represented by respective nodes in the motion planning graph. The path analyzer 356 may use or execute any variety of path finding algorithms, for example lowest cost path finding algorithms, taking into account cost values associated with each edge which represent likelihood of collision and/or a likelihood of triggering the safety system.

Various algorithms and structures to determine the least cost path may be used, including those that implement the Bellman-Ford algorithm, but others may be used, including, but not limited to, any such process in which the least cost path is determined as the path between two nodes in the motion planning graph such that the sum of the costs or weights of its constituent edges is minimized. This process improves the technology of motion planning for a robot 102, 302 by using a motion planning graph which represents motions of other robots as obstacles and collision detection to increase the efficiency and response time to find the “best” path to perform a task without collisions.

The motion planner 304 may optionally include a pruner 360. The pruner 360 may receive information that represents completion of motions by other robots, the information denominated herein as motion completed messages. Alternatively, a flag could be set to indicate completion. In response, the pruner 360 may remove an obstacle or portion of an obstacle that represents the now completed motion. That may allow generation of a new motion plan for a given robot, which may be more efficient or allow the given robot to attend to performing a task that was otherwise previously prevented by the motion of another robot. This approach advantageously allows the motion converter 350 to ignore timing of motions when generating obstacle representations for motions, while still realizing better throughput than using other techniques. The motion planner 304 may additionally cause the collision detector 352 to perform a new collision detection or assessment given the modification of the obstacles to produce an updated motion planning graph in which the edge weights or costs associated with edges have been modified, and to cause the cost setter 354 and path analyzer 356 to update cost values and determine a new or revised motion plan accordingly.

The motion planner 304 may optionally include an environment converter 363 that converts output (e.g., digitized representations of the environment) from optional sensors 362 (e.g., digital cameras) into representations of obstacles. Thus, the motion planner 304 can perform motion planning that takes into account transitory objects in the environment, for instance people, animals, etc.

The processor(s) 322 and/or the motion planner 304 may be, or may include, any logic processing units, such as one or more central processing units (CPUs), digital signal processors (DSPs), graphics processing units (GPUs), application-specific integrated circuits (ASICs), field programmable gate arrays (FPGAs), programmable logic controllers (PLCs), etc. Non-limiting examples of commercially available computer systems include, but are not limited to, the Celeron, Core, Core 2, Itanium, and Xeon families of microprocessors offered by Intel® Corporation, U.S.A.; the K8, K10, Bulldozer, and Bobcat series microprocessors offered by Advanced Micro Devices, U.S.A.; the A5, A6, and A7 series microprocessors offered by Apple Computer, U.S.A.; the Snapdragon series microprocessors offered by Qualcomm, Inc., U.S.A.; and the SPARC series microprocessors offered by Oracle Corp., U.S.A. The construction and operation of the various structure shown in FIG. 3 may implement or employ structures, techniques and algorithms described in or similar to those described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; International Patent Application Publication No. WO 2016/122840, filed Jan. 5, 2016, entitled “SPECIALIZED ROBOT MOTION PLANNING HARDWARE AND METHODS OF MAKING AND USING SAME”; and/or U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”.

Although not required, many of the implementations will be described in the general context of computer-executable instructions, such as program application modules, objects, or macros stored on computer- or processor-readable media and executed by one or more computer or processors that can perform obstacle representation, collision assessments, and other motion planning operations.

Motion planning operations may include, but are not limited to, generating or transforming one, more or all of: a representation of the robot geometry based on a robot geometric model 112 (FIG. 1), tasks 114 (FIG. 1), and the representation of volumes (e.g. swept volumes) occupied by robots in various states or poses and/or during movement between states or poses into digital forms, e.g., point clouds, Euclidean distance fields, data structure formats (e.g., hierarchical formats, non-hierarchical formats), and/or curves (e.g., polynomial or spline representations). Motion planning operations may optionally include, but are not limited to, generating or transforming one, more or all of: a representation of the static or persistent obstacles represented by static object data 118 (FIG. 1) and/or the perception data 120 (FIG. 1) representative of static or transient obstacles into digital forms, e.g., point clouds, Euclidean distance fields, data structure formats (e.g., hierarchical formats, non-hierarchical formats), and/or curves (e.g., polynomial or spline representations).

Motion planning operations may include, but are not limited to, determining or detecting or predicting collisions for various states or poses of the robot or motions of the robot between states or poses using various collision assessment techniques or algorithms (e.g., software based, hardware based).

In some implementations, motion planning operations may include, but are not limited to, determining one or more motion planning graphs, motion plans or road maps; storing the determined planning graph(s), motion plan(s) or road map(s); and/or providing the planning graph(s), motion plan(s) or road map(s) to control operation of a robot.

In one implementation, collision detection or assessment is performed in response to a function call or similar process, and returns a Boolean value thereto. The collision detector 352 may be implemented via one or more field programmable gate arrays (FPGAs) and/or one or more application specific integrated circuits (ASICs) to perform the collision detection while achieving low latency, relatively low power consumption, and increasing an amount of information that can be handled.

In various implementations, such operations may be performed entirely in hardware circuitry or as software stored in a memory storage, such as system memory 324a, and executed by one or more hardware processors 322, such as one or more microprocessors, digital signal processors (DSPs), field programmable gate arrays (FPGAs), application specific integrated circuits (ASICs), graphics processing units (GPUs) processors, programmed logic controllers (PLCs), electrically programmable read only memories (EEPROMs), or as a combination of hardware circuitry and software stored in the memory storage.

Various aspects of perception, planning graph construction, collision detection, and path search that may be employed in whole or in part are also described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS,” International Patent Application Publication No. WO 2016/122840, filed Jan. 5, 2016, entitled “SPECIALIZED ROBOT MOTION PLANNING HARDWARE AND METHODS OF MAKING AND USING SAME”; U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”; and U.S. Patent Application No. 62/856,548, filed Jun. 3, 2019, entitled “APPARATUS, METHODS AND ARTICLES TO FACILITATE MOTION PLANNING IN ENVIRONMENTS HAVING DYNAMIC OBSTACLES”. Those skilled in the relevant art will appreciate that the illustrated implementations, as well as other implementations, can be practiced with other system structures and arrangements and/or other computing system structures and arrangements, including those of robots, hand-held devices, multiprocessor systems, microprocessor-based or programmable consumer electronics, personal computers (“PCs”), networked PCs, mini computers, mainframe computers, and the like. The implementations or embodiments or portions thereof (e.g., at configuration time and runtime) can be practiced in distributed computing environments where tasks or modules are performed by remote processing devices, which are linked through a communications network. In a distributed computing environment, program modules may be located in both local and remote memory storage devices or media. However, where and how certain types of information are stored is important to help improve motion planning.

For example, various motion planning solutions “bake in” a roadmap (i.e., a motion planning graph) into the processor (e.g., FPGA), and each edge in the roadmap corresponds to a non-reconfigurable Boolean circuit of the processor. The design in which the planning graph is “baked in” to the processor, poses a problem of having limited processor circuitry to store multiple or large planning graphs and is generally not reconfigurable for use with different robots.

One solution provides a reconfigurable design that places the planning graph information into memory storage. This approach stores information in memory instead of being baked into a circuit. Another approach employs templated reconfigurable circuits in lieu of memory.

As noted above, some of the information (e.g., robot geometric models) may be captured, received, input or provided during a configuration time that is before run time. The received information may be processed during the configuration time to produce processed information (e.g., motion planning graphs) to speed up operation or reduce computation complexity during runtime.

During the runtime, collision detection may be performed for the entire environment, including determining, for any pose or movement between poses, whether any portion of the robot will collide or is predicted to collide with another portion of the robot itself, with other robots or portions thereof, with persistent or static obstacles in the environment, or with transient obstacles in the environment with unknown trajectories (e.g., people or humans).

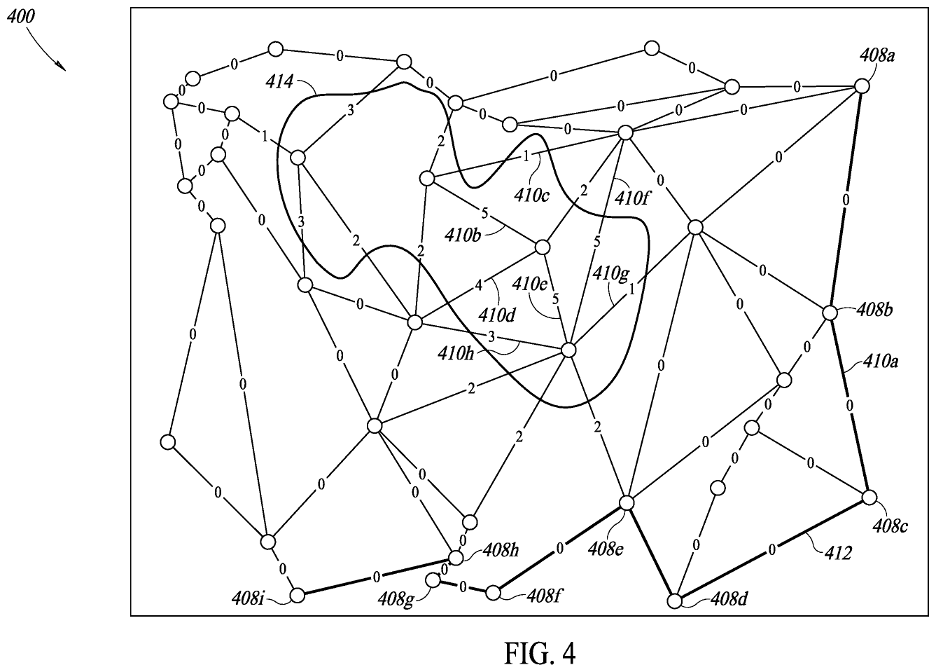

FIG. 4 shows an example planning graph 400 for the robot 102 (FIG. 1), 302 (FIG. 3) in the case where the goal of the robot 102, 302 is to perform a task while avoiding collisions with static obstacles and dynamic obstacles, the obstacles which can include other robots operating in the workcell or operational environment 104.

The planning graph 400 respectively comprises a plurality of nodes 408a-408i (represented in the drawing as open circles) connected by edges 410a-410h, (represented in the drawing as straight lines between pairs of nodes). Each node represents, implicitly or explicitly, time and variables that characterize a state of the robot 102, 302 in the configuration space of the robot 102, 302. The configuration space is often called C-space and is the space of the states or configurations or poses of the robot 102, 302 represented in the planning graph 400. For example, each node may represent the state, configuration or pose of the robot 102, 302 that may include, but is not limited to, a position, orientation or a combination of position and orientation. The state, configuration or pose may, for example, be represented by a set of joint positions and joint angles/rotations (e.g., joint poses, joint coordinates) for the joints of the robot 102, 302.

The edges in the planning graph 400 represent valid or allowed transitions between these states, configurations or poses of the robot 102, 302. The edges of planning graph 400 do not represent actual movements in Cartesian coordinates, but rather represent transitions between states, configurations or poses in C-space. Each edge of planning graph 400 represents a transition of a robot 102, 302 between a respective pair of nodes. For example, edge 410a represents a transition of a robot 102, 302, between two nodes. In particular, edge 410a represents a transition between a state of the robot 102, 302 in a particular configuration associated with node 408b and a state of the robot 102, 302 in a particular configuration associated with node 408c. Although the nodes are shown at various distances from each other, this is for illustrative purposes only and this is no relation to any physical distance. There is no limitation on the number of nodes or edges in the planning graph 400, however, the more nodes and edges that are used in the planning graph 400, the more accurately and precisely the motion planner may be able to determine the optimal path according to one or more states, configurations or poses of the robot 102, 302 to carry out a task since there are more paths to select the least cost path from.

Each edge is assigned or associated with a cost value which assignment may, for example, be updated at runtime. The cost value may represent a collision assessment with respect to a motion that is represented by the corresponding edge. The cost value may represent an assessment of a potential of a motion that is represented by the corresponding edge of causing a processor-based workcell safety system to trigger and thereby cause a stoppage, slowdown or creation of a precautionary occlusion. As explained herein, the safety monitoring rules 125c (FIG. 1) can be used to determine what conditions or situations will trigger the processor-based workcell safety system. The cost values (e.g., weights) assigned to edges may be increased for those edges corresponding to the transitions that are deemed likely to trigger the processor-based workcell safety system, to reduce the tendency to select a path that includes those transitions.

Typically, it is desirable for robot 102, 302 to avoid certain obstacles, for example other robots in a shared workcell or operational environment. In some situations, it may be desirable for robot 102, 302 to contact or come in close proximity to certain objects in the shared workcell or operational environment, for example to grip or move an object or work piece. FIG. 4 shows a planning graph 400 used by a motion planner to identify a path for robot 102, 302 in the case where a goal of the robot 102, 302 is to avoid collision with one or more obstacles while moving through a number of poses in carrying out a task (e.g., picking and placing an object).

Obstacles may be represented digitally, for example, as bounding boxes, oriented bounding boxes, curves (e.g., splines), Euclidean distance field, or hierarchy of geometric entities, whichever digital representation is most appropriate for the type of obstacle and type of collision detection that will be performed, which itself may depend on the specific hardware circuitry employed. In some implementations, the swept volumes in the roadmap are precomputed. Examples of collision assessment are described in International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS”; U.S. Patent Application 62/722,067, filed Aug. 23, 2018 entitled “COLLISION DETECTION USEFUL IN MOTION PLANNING FOR ROBOTICS”; and in International Patent Application Publication No. WO 2016/122840, filed Jan. 5, 2016, entitled “SPECIALIZED ROBOT MOTION PLANNING HARDWARE AND METHODS OF MAKING AND USING SAME.”

The motion planner or a portion thereof (e.g., collision detector 352, FIG. 3) determines or assesses a likelihood or probability that a motion or transition (represented by an edge) will result in a collision with an obstacle. In some instances, the determination results in a Boolean value, while in others the determination may be expressed as a probability.

For nodes in the planning graph 400 where there is a probability that direct transition between the nodes will cause a collision with an obstacle, the motion planner (e.g., cost setter 354, FIG. 3) assigns a cost value or weight to the edges of the planning graph 400 transitioning between those nodes (e.g., edges 410a, 410b, 410c, 410d, 410e, 410f, 410g, 410h) indicating the probability of a collision with the obstacle. In the example shown in FIG. 4, an area in C-space of relatively high probability is denoted as graph portion 414, but does not correspond to a physical area.

For example, the motion planner may, for each of a number of edges of the planning graph 400 that has a respective probability of a collision with an obstacle below a defined threshold probability of a collision, assign a cost value or weight with a value equal or close to zero. In the present example, the motion planner has assigned a cost value or weight of zero to those edges in the planning graph 400 which represent transitions or motions of the robot 102, 302 that do not have any or have very little probability of a collision with an obstacle. For each of a number of edges of the planning graph 400 with a respective probability of a collision with an obstacle in the environment above the defined threshold probability of a collision, the motion planner assigns a cost value or weight with a value substantially greater than zero. In the present example, the motion planner has assigned a cost value or weight of greater than zero to those edges in the planning graph 400 which have a relatively high probability of collision with an obstacle. The particular threshold used for the probability of collision may vary. For example, the threshold may be 40%, 50%, 60% or lower or higher probability of collision. Also, assigning a cost value or weight with a value greater than zero may include assigning a cost value or weight with a magnitude greater than zero that corresponds with the respective probability of a collision. In other implementations, the cost values or weights may present a binary choice between collision and no collision, there being only two cost values or weights to select from in assigning cost values or weights to the edges.

The motion planner or a portion thereof (e.g., rule analyzer 359, FIG. 3) determines or assesses a likelihood or probability that a motion or transition (represented by an edge) will result in the processor-based workcell safety system triggering a stoppage, slowdown or precautionary occlusion. For example, the motion planner or a portion thereof (e.g., rule analyzer 359, FIG. 3) may simulate a motion plan, determining whether any transitions will violate a safety rule (e.g., result in the robot or portion thereof passing too close to a human as defined by the safety monitoring rules 125c (FIG. 1) implemented by the processor-based workcell safety system). The motion planner may assign, set or adjust cost values or weights of each edge based on factors or parameters in addition to probability of collision, for example the probability of causing the processor-based workcell safety system to trigger a stoppage, slowdown or precautionary occlusion.

For example, as shown in the planning graph 400, the motion planner has assigned a cost value or weight of 5 to edges 410b, 410e, and 410f that have a higher probability of collision and/or a higher probability of triggering a stoppage, slowdown or precautionary occlusion, but has assigned a cost value or weight with a lower magnitude of 0 to edge 410a, and a magnitude of 1 to edges 410c and 410g, which the motion planner determined have a much lower probability of collision and/or much lower probability of triggering a stoppage, slowdown or precautionary occlusion.

After the motion planner sets a cost value or weight representing a probability of collision of the robot 102, 302 with an obstacle based at least in part on the collision assessment, optionally based on the probability of causing the processor-based workcell safety system to trigger a stoppage, slowdown or precautionary occlusion, and/or optionally based on other factors (e.g., latency, power consumption), the motion planner (e.g., path analyzer 356, FIG. 3) performs an optimization to identify a path 412 (indicated by bold line weight) in the resulting planning graph 400 that provides a motion plan for the robot 102, 302 as specified by the path with no or a relatively low potential of a collision with obstacles including other robots operating in a workcell or operational environment and/or with no or a relatively low potential of causing the processor-based workcell safety system to trigger a stoppage, slowdown or precautionary occlusion.

In one implementation, once all edge costs of the planning graph 400 have been assigned or set, the motion planner (e.g., path analyzer 356, FIG. 3) may perform a calculation to determine a least cost path to or toward a goal state represented by a goal node. For example, the path analyzer 356 (FIG. 3) may perform a least cost path algorithm from the current state of the robot 102, 302 in the planning graph 400 to possible states, configurations or poses. The least cost (closest to zero) path in the planning graph 400 is then selected by the motion planner. As explained above, cost may reflect not only probability of collision, and/or the probability of causing the processor-based workcell safety system to trigger a stoppage, slowdown or precautionary occlusion, but also other factors or parameters. In the present example, a current state, configuration or pose of the robot 102, 302 in the planning graph 400 is at node 408a, and the path is depicted as path 412 (bolded line path comprising segments extending from node 408a through node 408i) in the planning graph 400.

Although shown as a path in planning graph 400 with many sharp turns, such turns do not represent corresponding physical turns in a route, but logical transitions between states, configurations or poses of the robot 102, 302. For example, each edge in the identified path 412 may represent a state change with respect to physical configuration of the robot 102, 302 in the environment, but not necessarily a change in direction of the robot 102, 302 corresponding to the angles of the path 412 shown in FIG. 4.

FIG. 5 shows a high-level method 500 of operation of a processor-based system to implement safety monitoring of an operational environment to control robot operation in the operational environment along with validation of a safety monitoring system, according to at least one illustrated implementation. The method 500 may, for example, be executed by one or more processors 134 (FIG. 1) of a processor-based safety system 130 (FIG. 1), for example one or more processors 222 (FIG. 2) of a processor-based workcell safety system 200 (FIG. 2). The processor-based workcell safety system 200 may, for example, optionally be communicatively coupled with a robot control system 300 (FIG. 3) that generates motion plans and/or controls operation of one or more robots 102a, 102b (FIG. 1) in the operational environment. As used herein and in the claims, operation or movement of a robot includes operation or movement of an entire robot, or a portion thereof (e.g., robotic appendage, end-of-arm tool, end effector). While generally discussed in terms of a robot, the various operations and acts are applicable to operational environments with one, two or even more robots operating therein.

The method 500 starts at 502. For example, the method 500 may start in response to a powering ON of a processor-based workcell safety system 200, robot control system 300 and/or robot 102, or a call or invocation from a calling routine. The method 500 may execute continually or even continuously, for example during operation of one or more robots 102.

At 504, the processor(s) 222 (FIG. 2) of a processor-based workcell safety system 200 receives information from a first sensor 132a (FIG. 1) positioned and oriented to detect a position of a human, if any, in at least a first portion of the operational environment.

At 506, the processor(s) 222 (FIG. 2) of a processor-based workcell safety system 200 receives information from at least a second sensor 132b (FIG. 1) positioned and oriented to detect a position of a human, if any, in at least a second portion of the operational environment. The second portion of the operational environment at least partially overlaps with the first portion of the operational environment. The second sensor 132b is advantageously heterogeneous with respect to the first sensor 132a. Notably, at 506, the processor-based workcell safety system 200 may receive information from a third, fourth or even more sensors 132, each associated with respective positions and orientations or fields of view, which are positioned and oriented to monitor at least a portion of the operational environment to detect a position of a human, if any, in at least the portion of the operational environment. While in some implementations two or more sensors 132 may share certain operational characteristics (e.g., sensor operational modality, make and model, sampling rate), diversity in operational characteristics between the various sensors is non-intuitively desirable to increase overall operational safety.

The first, the second, and any additional sensors 132 may be sensors that are dedicated to safety monitoring, and may form part of a dedicated processor-based workcell safety system 200. Alternatively, the sensors 122 (FIG. 1) used for motion planning may also provide sensor data to the processor-based workcell safety system 200 for performing safety monitoring. The robot control system 109a, 109b (FIG. 1) may be distinct from, and optionally communicatively coupled to, the processor-based workcell safety system 200. The first, the second, and any additional sensors 132 may advantageously be low cost off the shelf sensors. As noted above, the set including the first, the second, and any additional sensors 132 may be a heterogeneous set of sensors, where two, more or even all the sensors of the processor-based workcell safety system 200 have different operational characteristics from one another. Such may advantageously achieve a desired margin of safety from common off the shelf sensors, for example, a margin of safety typically associated with substantially more expansive safety certified sensors.

At 508, at least one processor 222 (FIG. 2) of the processor-based workcell safety system 200 performs an assessment of one or more operational states of the first and at least the second sensor, and other sensors 132 of the processor-based workcell safety system 200 when present. The assessment may be based, at least in part, on one or more sets of sensor state rules 125a (FIG. 1) applied to assess one, two or more operational states or conditions for each of the sensors 132 or assess operational states or conditions between the sensors 132 of the processor-based workcell safety system 200 (e.g., comparing output of two or more sensors), examples of which are described herein. The operational states or conditions or assessment of the operational states or conditions may indicate whether one or more sensors 132 are operating as expected and/or operating within a defined set of performance parameters, states, or conditions and thus can be relied on for providing a safe operational environment.

The assessment may be based on one or more sets of sensor state rules 125a that specify one or more of a variety of factors, operating states, conditions, parameters, criteria and/or rules. For example, the at least one processor 222 (FIG. 2) of the processor-based workcell safety system 200 may advantageously assess whether the sensors 132 are operating correctly. For instance, the at least one processor 222 (FIG. 2) of the processor-based workcell safety system 200 may advantageously assess whether the information received from the first and at least the second sensors 132 indicates that the sensors 132 of the processor-based workcell safety system 200 are providing sensed information in an expected way (e.g., at a defined or nominal sampling rate; two or more sensors 132 are sensing the same event consistently), and/or that none of the sensors 132 are stuck (i.e., erroneously repeatedly providing the same identical stale information over and over whereas conditions in the operational environment have changed and different information should be provided over the relevant period of time). Some of the assessments (e.g., sampling rate) may be performed for each sensor 132 individually, while other assessments (e.g., comparing information sensed by two or more sensors 132) may be performed for two or more sensors 132 of the processor-based workcell safety system 200 collectively.

For example, each sensor 132 may be associated with a respective sampling rate. The rules may define a respective acceptable sampling range or a percentage of sampling rate error that is considered to be acceptable, or conversely similar values that are considered unacceptable. Also for example, the rules may define a respective amount of time that a sensor may be stuck or a frequency for confirming that the sensor is not stuck, that is considered acceptable, or conversely similar values that are considered not acceptable.

At 510, at least one processor 222 of the processor-based workcell safety system 200 performs a system status validation, validating a status (i.e., system status) of the processor-based workcell safety system 200 based at least in part on one or more sets of systems validation rules 125b (FIG. 1). Validation may be based, for instance, on the determined operational states of the sensors 132. The system validation rules 125b may, for instance, specify rules for select sensors 132 and/or one or more select groups of sensors 132 (e.g., all sensors must be operational; sensors identified as necessary must all be operational while other sensors may or may not be operational; a majority of sensors of a set of sensors must be in agreement). The processor(s) 222 of the processor-based workcell safety system 200 may assess or otherwise apply the system validation rules 125b to determine whether there are sufficient sensors 132 that are operating within normal or acceptable bounds (i.e., no fault condition, operational state) to rely on the processor-based workcell safety system 200 for ensuring safety certified operation. Where there are sufficient sensors 132 that are operating within normal or acceptable bounds to rely on the processor-based workcell safety system 200 to ensure safety certified operation, the processor(s) 222 of the processor-based workcell safety system 200 may identify or indicate the existence of a non-anomalous system status. Conversely, where there are insufficient sensors 132 that are operating within normal or acceptable bounds (i.e., fault condition, inoperable state) to rely on the processor-based workcell safety system 200 to ensure safety certified operation, the processor(s) 222 of the processor-based workcell safety system 200 may identify or indicate the existence of an anomalous system status.

For example, the system validation rules 125b may specify how many, and/or which sensors 132 may be considered inoperative or not reliable for an anomalous system condition to exist. The system validation rules 125b may specify that an inoperable or default sensor state for any single sensor 132 constitutes or indicates an anomalous system status for the system. Additionally or alternatively, the system validation rules 125b may specify a set of two or more specific sensors 132 for which an inoperable or default sensor state for one or a combination of the specific sensors 132 constitutes or indicates an anomalous system status for the system. For instance, an anomalous system status may exist if one, two, more or even all of the sensors 132 of the set are faulty, inoperative or potentially faulty or potentially inoperative. Alternatively, the system validation rules 125b may define an anomalous system status for the processor-based workcell safety system 200 to exist when there is no consistency between a majority of sensors 132. Where there is consistency between a majority of sensors 132, the at least one processor 222 may determine that the sensors 132 as a group or set are sufficiently reliable to provide safe operation within the operational environment or some portion thereof.

At 512, at least one processor 222 of the processor-based workcell safety system 200 determines whether an outcome of the assessment based on the system validation rules 125b indicates that an anomalous system status exists for the processor-based workcell safety system 200.

In response to the validation indicating that an anomalous system status does exist for the processor-based workcell safety system 200 (e.g., not all sensors 132 operating within defined operational parameters, an insufficient number of sensors 132 operating within defined operational parameters, a majority of sensors 132 not operating consistently with one another within defined operational parameters), at 514 the at least one processor 222 provides a signal to at least in part control operation of the robot(s) 102 (FIG. 1), stopping movement, slowing movement, adding a precautionary occlusion, or otherwise inhibiting motion of one or more robots 102. For example, the at least one processor 222 may provide a signal that prevents or slows movement of the robot(s) 102 at least until the anomalous system status is alleviated, for instance providing a signal to a robot control system 109a, 109b (FIG. 1) or a motion controller 320 (FIG. 3) of the robot(s) 102 (FIG. 1). Also for example, the at least one processor 222 may provide a signal that indicates an area of the operational environment 104 (FIG. 1) to be treated as precautionarily occluded for motion planning, for example an area covered by one or more sensors 132 that have faulty or inoperable operational states, for instance providing a signal to a robot control system 109a, 109b or a motion controller 320 of the robot(s) 102. The method 500 then terminates at 524.

In response to the validation indicating that an anomalous system status does not exist for the processor-based workcell safety system 200 (e.g., all sensors 132 operating within defined operational parameters, a sufficient number of sensors 132 operating within defined operational parameters, a majority of sensors 132 operating consistently with one another within defined operational parameters), at 516 at least one processor 222 (FIG. 2) of the processor-based workcell safety system 200 (FIG. 2) monitors the operational environment 104 (FIG. 1) for occurrences of violations of safety monitoring rules 125c (FIG. 1) To monitor the operational environment for safety rule violations the processor(s) 222 may employ sensor data that represents objects in the operational environment 104 (FIG. 1). The processor(s) 222 may identify objects that are, or that appear to be, humans. The processor(s) 222 may determine a current position of one or more humans in the operational environment and/or a three-dimensional area occupied by the human(s). The processor(s) 222 may, optionally predict a path or a trajectory of the human over a period of time and/or a three-dimensional area occupied by the human(s) over the period of time. For instance, the processor(s) 222 may determine the path or trajectory or three-dimensional area based on a current position of the human(s) and based on previous movements of the human(s), and/or based on predicted behavior or training of the human(s). The processor(s) 222 may employ artificial intelligence or machine-learning to predict the path or trajectory of the human. The processor(s) 222 may determine a current position of one or more robots and/or a three-dimensional area occupied by the robot(s) over the period of time. For instance, the processor(s) 222 may determine the path or trajectory or three-dimensional area based on a current position of the robot(s) and a motion plan for the robot.

For example the processor(s) 222 may determine whether the position and/or predicted path or trajectory of the human(s) with respect to the position and/or path or trajectory of the robot(s) will violate one or more safety monitoring rules 125c (FIG. 1). For example, a violation of one or more safety monitoring rules 125c may be determined to exist where a motion of the human(s) and/or robot(s) causes a distance between the human(s) and the robot(s) to fall within a defined threshold safety distance. Such may be determined based on a straight-line distance calculation, but may also be determined based on the operational characteristics of certain sensors 132 (FIG. 1). For example, such may account for a resolution or granularity of a sensor, for instance treating the operational environment 104 (FIG. 1) or a portion thereof as segmented into unitary regions (e.g., of equal or unequal sizes), where the safety monitoring rules 125c require a separation of at least a defined number of unitary regions to be maintained between the human(s) and the robot(s) in order to avoid triggering a stoppage, slowdown, or precautionary occlusion.

At 518, at least one processor 222 (FIG. 2) of the processor-based workcell safety system 200 (FIG. 2) determines whether one or more of the safety rules 125c (FIG. 1) have been violated. A safety rule may be violated where, for example a human is too close to a to a robot 102 or a path or trajectory of a human will come too close to a robot 102 or too close to a path or trajectory of a robot 102, with closeness or proximity defined as straight line distance or by some number of units away from one another.

In response to determination that the safety monitoring rules 125c (FIG. 1) were not violated, at 520 the at least one processor 222 provides a signal to at least in part control operation of the robot(s) 102, allowing operation or movement of the robot(s). For example, the at least one processor 222 may provide a signal that allows one or more robots 102 to move, for instance a signal to a robot control system 109a, 109b (FIG. 1) or a motion controller 320 (FIG. 3) of the robot(s) 102. Also for instance, the at least one processor 222 may provide a signal that indicates that an area of the operational environment is not to be represented as occluded for use in motion planning. In some implementations, a default condition may be to indicate the entire workcell or operational environment 104 (FIG. 1) as occluded, and the at least one processor 222 may thus provide a signal that allows relaxation of the assumption that the entire workcell or operational environment 104 is occluded in response to determining that a system status of the processor-based workcell safety system 200 is a non-anomalous system status (e.g., sufficient sensor coverage is provided by sensors 132 with non-faulty or operable sensor states). Control may then return to 504 where portions of the method 500 are repeated.

In response to detection of a violation of one or more of the safety monitoring rules 125c (FIG. 1), at 522 the at least one processor 222 provides a signal halting, slowing or otherwise inhibiting operation (e.g., movement) of one or more robots. The processor(s) 222 may, for example provide a signal to a robot control system 300 (FIG. 3) to stop or slow movement, or provide a signal to a motion planner 110a 110b (FIG. 1) to identify one or more areas or regions as occluded for motion planning purposes. The method 500 then terminates at 524, for example until invoked again. In some implementations, the method 500 may operate continually or even periodically, for example while a robot or portion thereof is powered.

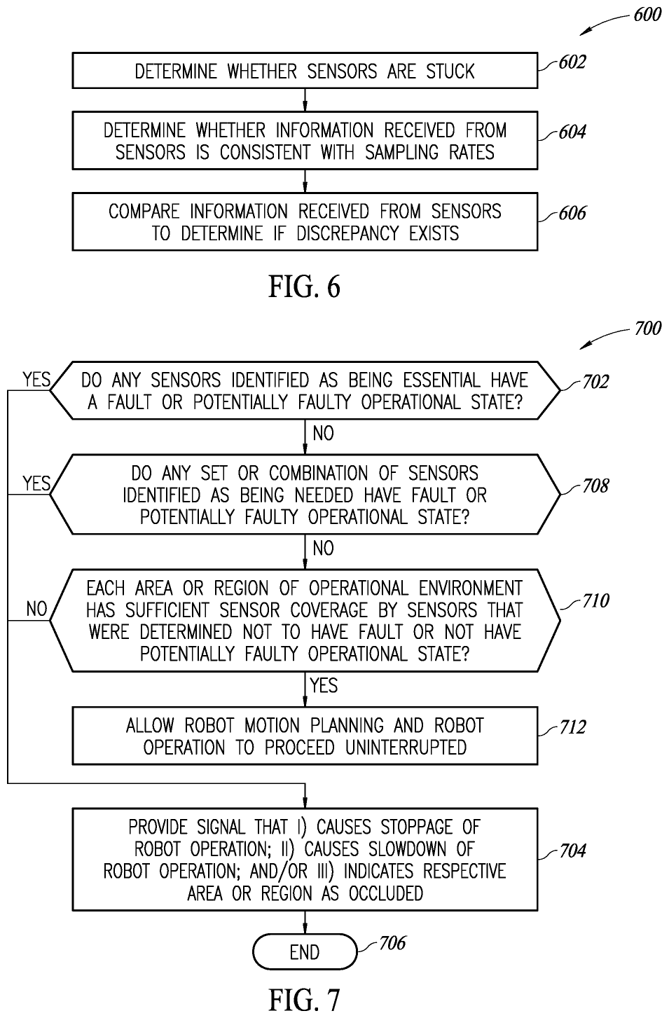

FIG. 6 shows a low-level method 600 of operation of a processor-based system to implement safety monitoring of an operational environment to control robot operation in the operational environment along with validation of a safety monitoring system, according to at least one illustrated implementation. The method 600 may, for example, be executed by one or more processors 222 (FIG. 2) of a processor-based workcell safety system 200 (FIG. 2). The processor-based workcell safety system 200 may, for example, optionally be communicatively coupled with a robot control system 300 (FIG. 3) that generates motion plans and/or controls operation of one or more robots 102 (FIG. 1) in the operational environment 104 (FIG. 1). The method 600 may, for example, be performed as part of assessing one or more operational states of the sensors 508 (FIG. 5).

At 602, at least one processor 222 determines whether the information received from the first and at least the second sensors indicates that either or both of the first or the second sensors are stuck (i.e., erroneously repeatedly sending the same stale data or information where activity in the area or region covered by the sensor has changed over that time).

For example, the at least one processor 222 may determine whether a fiducial 111 (FIG. 1) represented in the information received from the first and at least the second sensors has moved over a period of time. Also for example, the at least one processor may determine whether a movement of a fiducial 111 represented in the information received from the first and at least the second sensors is consistent with an expected movement of the fiducial 111 over a period of time.

In at least some implementations, the fiducial 111a is a portion of the robot 102 or carried by the portion of the robot 102. In such implementations, the at least one processor 222 may, for example, determine whether a movement of a fiducial 111a represented in the information received from the first and the second sensors 132 is consistent with an expected movement of the fiducial 111a over a period of time. Such may, for instance, include determining whether the movement of the fiducial 111a matches a movement of the portion of the robot 102a over the period of time. Such may, for example, be performed using the known joint angles of the robot 102a during the transition or movement.

In at least some implementations, the fiducial 111b is separate and distinct from the robots 102, and moves separately from the robots 102. In such implementations, the at least one processor 222 may, for example, determine whether a movement of a fiducial 111b represented in the information received from the first and the second sensors 132 is consistent with an expected movement of the fiducial 111b over a period of time. Such may, for example, include determining whether the movement of the fiducial 111b matches an expected movement of the fiducial 111b over the period of time.

In at least some implementations at least one of the first or the second sensors 132 move in a defined pattern during a period of time. In such implementations, the at least one processor 222 may, for example, determine whether an apparent movement of a fiducial 111 represented in the information received from the first and the second sensors 132 is consistent with an expected apparent movement of the fiducial 111 over a period of time based on the movement of the first or the second sensors 132 during the period of time.

At 604, at least one processor 222 determines whether information received from the sensors 132 is consistent with a respective sampling rate of the sensors. For example, a first sensor 132 may take the form of a digital camera that captures images at 30 frame per second. Thus, the information received from the sensor 132 is expected to have thirty frames every second. A laser scanner may capture information at 120 samples every second, thus the information received from the sensor is expected to have 120 sets of data every second.

At 606, at least one processor 222 compares the information received from the first and at least the second sensors 132 for the at least partial overlap of the second portion with the first portion of the operational environment 104 (FIG. 1) to determine if there is a discrepancy. For example, there may be a fixed object, or moving object (e.g., a portion of the robot 102) occupying a space that is in the field of view of two or more sensors 132. The at least one processor 222 analyzes the sensed information from each of those sensors 132 to determine that the fixed or moving object is detected by each of the sensors 132, and/or that a pose (i.e., position and/or orientation) of the object as captured by each of the sensors 132 is consistent with a pose of the object as captured by the other sensors 132. In assessing pose, the at least one processor may account for the different respective fields of view of the sensors 132, for example normalizing one or more fields of view with respect to another or with respect to a defined reference frame. For instance, an image capture by a first image sensor 132 may be manipulated (e.g., translated and/or rotated in three dimensions) based on a field of view of the first image sensor relative to a second image sensor, for instance via a graphics processing unit (GPU). The at least one processor 222 may then perform a comparison between the image captured by the second sensor 132 and the manipulated image from first sensor 132 to determine that both sensors captured the object consistently with one another. While described in terms of image-based sensors 132 for convenience of example, and while the term of field of view is used, the sensors 132 are not limited to image-based sensors 132. Nor is comparison of information provided by two or more sensors 132 limited to sensors 132 with the same operational modalities (e.g., information collected by a PIR motion sensor and by a laser sensor may be compared).

FIG. 7 shows a low-level method 700 of operation of a processor-based system to implement safety monitoring of an operational environment to control robot operation in the operational environment along with validation of a safety monitoring system, according to at least one illustrated implementation. The method 700 may, for example, be executed by one or more processors 222 (FIG. 2) of a processor-based workcell safety system 200 (FIG. 2). The processor-based workcell safety system 200 may, for example, optionally be communicatively coupled with a robot control system 300 (FIG. 3) that generates motion plans and/or controls operation of one or more robots in the operational environment. The method 700 may, for example, be performed as part of determining whether an outcome of the system validation (510 of the method 500 of FIG. 5) indicates an anomalous system status (512 of the method 500 of FIG. 5) exists for the safety system.

At 702, at least one processor 222 of the processor-based workcell safety system 200 determines whether any sensors 132 (FIG. 1) that are identified as being essential, if any, were determined to have a fault or a potentially faulty operational state. The determination of the existence or absence of a fault or potentially faulty operational state may have been performed as part of the performance of the method 600 (FIG. 6), for example by verifying whether the sensor 132 is stuck, whether the sensor 132 is providing samples at a nominal sampling rate, whether the output of the sensor 132 is makes sense or is consistent with expected output or with output of other sensors 132.

In response to a determination that one or more sensors 132 identified as being essential have a fault or potentially faulty operational state, the at least one processor 222 provides a signal at 704 that either: i) causes stoppage of robot operation; ii) causes a slowdown in robot operation; and/or iii) indicates an area or region to be identified as occluded. The method 700 may then terminate at 706, until the fault is resolved, and the method 700 is invoked again. Alternatively, in response to a determination that one or more sensors identified as being essential does not have a fault or potentially faulty operational state, control passes to 708.

At 708, at least one processor 222 of the processor-based workcell safety system 200 determines whether any set or combination of sensors 132 that are identified as being needed, if any, were determined to have a fault or a potentially faulty operational state. The determination of the existence or absence of a fault or potentially faulty operational state may have been performed as part of the performance of the method 600 (FIG. 6), for example by verifying whether the sensor 132 is stuck, whether the sensor 132 is providing samples at a nominal sampling rate, whether the output of the sensor 132 is makes sense or is consistent with expected output or with the output of other sensors 132.

In response to a determination that one or more sensors 132 of any set or combination of sensors 132 that are identified as being needed have a fault or potentially faulty operational state, the at least one processor 222 provides a signal at 704 that either: i) causes stoppage of robot operation; ii) causes a slowdown in robot operation; and/or iii) indicates an area or region to be identified as occluded. The method 700 may then terminate at 706, until the fault is resolved, and the method 700 is invoked again. Alternatively, in response to a determination that one or more of any set or combination of sensors 132 that are identified as being needed does not have a fault or potentially faulty operational state, control passes to 710.

At 710, at least one processor 222 of the processor-based workcell safety system 200 determines whether each area or region of the operational environment has sufficient sensor coverage by sensors 132 that were determined not to have a fault or not have a potentially faulty operational state. The determination of the absence or existence of a fault or potentially faulty operational state may have been performed as part of the performance of the method 600 (FIG. 6), for example by verifying whether the sensor 132 is stuck, whether the sensor 132 is providing samples at a nominal sampling rate, whether the output of the sensor 132 is makes sense or is consistent with expected output or with the output of other sensors 132.

In response to a determination that one or more areas or regions of the operational environment 104 (FIG. 1) does not have sufficient sensor coverage by sensors 132 that were determined not to have a fault or not have a potentially faulty operational state, the at least one processor 222 provides a signal at 704 that either: i) causes stoppage of robot operation; ii) causes a slowdown in robot operation; and/or iii) indicates the respective area or region to be identified as occluded. The method 700 may then terminate at 706, until the fault is resolved, and the method 700 is invoked again. Alternatively, in response to a determination that the areas or regions have sufficient sensor coverage by sensors 132 that were determined not to have a fault and not have a potentially faulty operational state, at 712 the processor 222 allows robot motion planning and/or robot operation to proceed, uninterrupted.

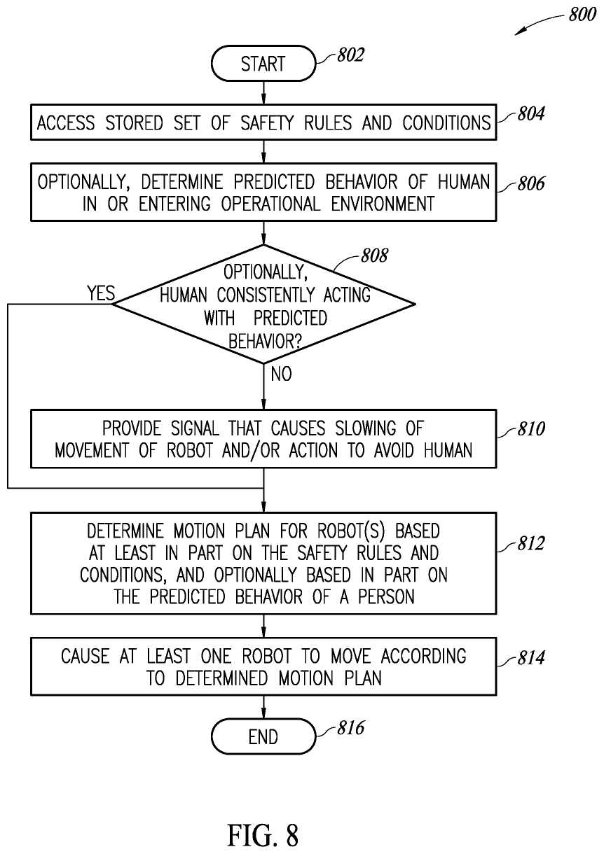

FIG. 8 shows a method 800 of operation of a processor-based system to control robot operation in an operational environment to reduce triggering of a processor-based workcell safety system, according to at least one illustrated implementation. The method 800 may, for example, be executed by one or more processors 322 (FIG. 3) of a robot control system 300 (FIG. 3) that generates motion plans and/or controls operation of one or more robots 102 (FIG. 1) in the operational environment 104 (FIG. 1). The robot control system 300 may, for example, optionally be communicatively coupled with a processor-based workcell safety system.

The processor-based workcell safety system 200 evaluates safety conditions based on a set of safety monitoring rules 125c (FIG. 1) which include a number of conditions in which the processor-based workcell safety system 200 triggers at least one of a slow down or a stoppage of operation of the at least one robot 102 that operates in the workcell or operational environment 104. For example, the processor-based workcell safety system 200 may trigger a stoppage or slowdown, or even cause a portion of the operational environment 104 to be indicated as occluded as a precaution in response to detection of a transient object (e.g., a human or potentially a human) located within a defined distance of a portion of the robot(s) 102 or within a defined distance of a projected trajectory of a portion of the robot(s) 102. The distance may or may not be a straight line distance, and may, for example take into account a resolution of the particular sensor 132 (FIG. 1). Also for example, the processor-based workcell safety system 200 may trigger a stoppage or slowdown, or even cause a portion of the operational environment 104 to be indicated as occluded as a precaution in response to detection of a predicted collision or close approach of a trajectory of a transient object (e.g., a human or potentially a human) with a projected trajectory of a portion of one or more robots 102.

Stoppages, slowdowns and precautionary occlusions hinder robot operation, and it would be advantageous to limit or even avoid such when possible. To alleviate such stoppages, slowdowns and precautionary occlusions, the processor-based robot control system 300 (FIG. 3) advantageously takes into account the safety monitoring rules 125c (FIG. 1) that trigger the processor-based workcell safety system 200 (FIG. 2) when performing motion planning.

The method 800 starts at 802. For example, the method 800 may start in response to a powering ON of a processor-based system (e.g., processor-based robot control system 300; processor-based workcell safety system 200), in response to a powering ON of one or more robots 102, or in response to a call or invocation from a calling routine. The method 800 may execute continually, for example during operation of one or more robots 102.

At 804, at least one processor 322 (FIG. 3) of the processor-based robot control system 300 accesses a stored set of the safety monitoring rules 125c (FIG. 1) that are implemented by the processor-based workcell safety system 200 (FIG. 2). The set of safety monitoring rules 125c (FIG. 1) may be stored locally at the processor-based robot control system 300, but preferably stored at and retrieved from the processor-based workcell safety system 200 to ensure the most up-to-date set of rules and conditions are used.

Optionally at 806, at least one processor 322 of the processor-based robot control system 300 determines a predicted behavior of a human (e.g., operator) in the workcell or operational environment 104 or who appears to be likely to enter the workcell or operational environment 104. The at least one processor 322 may, for example, determine the predicted behavior of the person in the workcell or operational environment 104 using machine-learning or artificial intelligence, being trained on a dataset of similar operational environments and robot scenarios. The at least one processor 322 may, for example, determine the predicted behavior of the human in the workcell or operational environment 104 based at least in part on a set of operator training guidelines, which specify positions or locations and times and/or speed of movement of operators and other humans when present in the operational environment 104. The at least one processor 222 may, for example, determine a predicted trajectory (e.g., path, speed) of a human at least partially through the workcell or operational environment 104.

Optionally at 808, the at least one processor 322 of the processor-based robot control system 300 may, for example, determine whether the human is acting consistently with the predicted behavior. In response to a determination that the human is not acting consistently with the predicted behavior, the at least one processor may, for example, provide a signal at 810 that causes a slowing of movement of the robot(s) 102 and/or causes another action that reduces a likelihood or probability of the robot(s) 102 colliding with the unpredictable human, for example causing the robot(s) 102 to move away from a current position of the human. Control then passes to 812. In response to a determination that the human is acting consistently with the predicted behavior, control passes directly to 812.

At 812, at least one processor 322 of the processor-based robot control system 300 determines a motion plan for the at least one robot 102 (FIG. 1) based at least in part on the safety monitoring rules 125c (FIG. 1) for the processor-based safety system 200 (FIG. 2), and optionally based in part on the predicted behavior of a person, if any, in the operational environment 104. The at least one processor 322 may, for example, determine a motion plan for the at least one robot 102 that at least reduces a probability of the processor-based workcell safety system 200 (FIG. 2) triggering at least one of the slow down or the stoppage of operation of the at least one robot 102, or that reduces or even eliminates that use of precautionary occlusions.

The at least one processor 322 may, for example, determine a motion plan based on a resolution or granularity of at least one component (e.g., sensor 132) of the processor-based workcell safety system 200. The at least one processor 322 may, for example, determine a motion plan based on a resolution or granularity of at least one sensor 132 of the processor-based workcell safety system 200. For instance, the at least one processor 322 may determine a motion plan based on a set of dimensions of the grid of regions (e.g., wedge or triangular shaped regions, rectangular regions, hexagonal regions), for instance where the sensor 132 (e.g., laser-based sensor) divides the operational environment or portion thereof into a grid or array of sections. Where predictive behavior of a human has been determined, the at least one processor 322 of the processor-based robot control system 300 may, for example, determine a motion plan for the at least one robot 102 (FIG. 1) based in part on the safety monitoring rules 125c (FIG. 1) for the processor-based safety system 200 and based at least in part of the determined predicted behavior of the person in the operational space or workcell 104. The at least one processor 322 may, for example, determine the motion plan for the at least one robot 102 based at least in part of the determined predicted behavior (e.g., position/location, time, speed, trajectory) of the human.

The at least one processor 322 of the processor-based robot control system 300 may employ various techniques to determine a motion plan that advantageously reduces or even eliminates a probability of the processor-based workcell safety system 200 triggering at least one of the slow down or the stoppage of operation of the at least one robot 102, or that reduces or even eliminates that use of precautionary occlusions. For example, the at least one processor 322 may adjust a cost value or weight associated with edges that represent transitions between robot configurations that would violate one or more safety rules or conditions specified by the set of safety monitoring rules 125c (FIG. 1) enforced by the processor-based workcell safety system 200 or otherwise trigger the processor-based workcell safety system 200 to cause a stoppage, slowdown, or precautionary occlusion. The cost value or weight may be adjusted (e.g., increased) to reduce the probability that the associated transition is selected during a least cost path analysis of a planning graph by the processor-based robot control system 300. The weight may be adjusted even where the transition would not necessarily result in a collision between a portion of a robot and a human, but rather where the given transition would necessarily or would likely cause the processor-based workcell safety system 200 to be triggered and intervene (e.g., cause a stoppage, slowdown, or precautionary occlusion).

After the motion plan is determined, control may pass to 814.

At 814, at least one processor 322 of the processor-based robot control system 300 causes the at least one robot 102 to move according to the determined motion plan. For example, the at least one processor 322 of the processor-based robot control system 300 may provide signals to one or more motion controllers 320 (FIG. 3) for example motor controllers that control movement (e.g., control motors) of one or more robots 102 (FIG. 1).

The method 800 terminates at 816, for example until invoked again. In some implementations, the method 800 may operate continually or even periodically, for example while a robot or portion thereof is powered.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Boolean circuits, Application Specific Integrated Circuits (ASICs) and/or FPGAs. However, those skilled in the art will recognize that the embodiments disclosed herein, in whole or in part, can be implemented in various different implementations in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being implemented in hardware, for example in one or more FPGAs or ASICs.

The various embodiments described above can be combined to provide further embodiments. All of the commonly assigned US patent application publications, US patent applications, foreign patents, and foreign patent applications referred to in this specification and/or listed in the Application Data Sheet, including but not limited to U.S. Patent Application Ser. No. 63/105,542, filed Oct. 26, 2020, entitled “SAFETY SYSTEMS AND METHODS EMPLOYED IN ROBOT OPERATIONS”, International Patent Application No. PCT/US2017/036880, filed Jun. 9, 2017 entitled “MOTION PLANNING FOR AUTONOMOUS VEHICLES AND RECONFIGURABLE MOTION PLANNING PROCESSORS,” International Patent Application Publication No. WO 2016/122840, filed Jan. 5, 2016, entitled “SPECIALIZED ROBOT MOTION PLANNING HARDWARE AND METHODS OF MAKING AND USING SAME”; U.S. Patent Application No. 62/616,783, filed Jan. 12, 2018, entitled, “APPARATUS, METHOD AND ARTICLE TO FACILITATE MOTION PLANNING OF AN AUTONOMOUS VEHICLE IN AN ENVIRONMENT HAVING DYNAMIC OBJECTS”; U.S. Patent Application Ser. No. 62/626,939, filed Feb. 6, 2018, entitled “motion planning of A robot STORING A discretized ENVIRONMENT ON ONE OR MORe PROCESSORS and IMPROVED OPERATION OF SAME”, U.S. Patent Application No. 62/856,548, filed Jun. 3, 2019, entitled “APPARATUS, METHODS AND ARTICLES TO FACILITATE MOTION PLANNING IN ENVIRONMENTS HAVING DYNAMIC OBSTACLES”, U.S. Patent Application No. 62/865,431, filed Jun. 24, 2019, entitled “MOTION PLANNING FOR MULTIPLE ROBOTS IN SHARED WORKSPACE”, and International Patent Application PCT/US2020/039193, filed Jun. 23, 2020 and entitled “MOTION PLANNING FOR MULTIPLE ROBOTS IN SHARED WORKSPACE”, are each incorporated herein by reference, in their entirety. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1.-74. (canceled)

75. A method of operation in a motion planning system to generate motion plans that are safety system aware, the motion plans executable to control one or more robots, the method comprising:
performing collision assessment by a processor-based motion planner for each edge of a first motion planning graph, the first motion planning graph comprising a plurality of nodes and a plurality of edges, each of the nodes representing a respective configuration of a first robot and each of the edges representing a respective transition between a respective pair of the configurations of the first robot that are represented by a respective pair of the nodes that are connected by the respective edge;
for two or more of the edges of the first motion planning graph, determining whether a respective transition represented by the respective edge in the first motion planning graph will violate one or more safety rules of a set of safety monitoring rules of a processor-based workcell safety system that monitors an environment in which at least the first robot will operate;
for each of the two or more edges of the first motion planning graph, setting a cost for the respective edge in the first motion planning graph based at least in part on both: i) the collision assessment and ii) the determination of whether a respective transition represented by the respective edge in the motion plan graph will violate one or more safety rules of the set of safety monitoring rules of the processor-based workcell safety system; and
generating a first executable motion plan based at least in part on the first motion planning graph with the cost set for each of the two or more edges, the first executable motion plan executable by a robot control system to control operation of the first robot.

76. The method of claim 75 wherein setting a cost for the respective edge in the first motion planning graph based at least in part on both: i) the collision assessment and ii) the determination of whether the respective transition represented by the respective edge in the motion plan graph will violate a safety rule of a set of safety monitoring rules of a processor-based workcell safety system includes setting the cost for the respective edge in the first motion planning graph where the cost represents an assessed probability of collision associated with the respective transition represented by the respective edge.

77. The method of claim 75 wherein setting a cost for the respective edge in the first motion planning graph based at least in part on both: i) the collision assessment and ii) the determination of whether respective transition represented by the respective edge in the motion plan graph will violate a safety rule of a set of safety monitoring rules of a processor-based workcell safety system includes setting the cost for the respective edge in the first motion planning graph where the cost represents an assessed probability of violation of at least one of the set of safety monitoring rules associated with the respective transition represented by the respective edge.

78. The method of claim 75 wherein setting a cost for the respective edge in the first motion planning graph based at least in part on both: i) the collision assessment and ii) the determination of whether respective transition represented by the respective edge in the motion plan graph will violate a safety rule of a set of safety monitoring rules of a processor-based workcell safety system includes setting the cost for the respective edge in the first motion planning graph where the cost represents an assessed probability of collision associated with the respective transition represented by the respective edge and represents an assessed probability of violation of at least one of the set of safety monitoring rules associated with the respective transition represented by the respective edge.

79. The method of claim 75 wherein generating a first executable motion plan based at least in part on the first motion planning graph with the cost set for each of the two or more edges includes performing a least cost analysis on the first motion planning graph to identify a path between two configurations of the first robot.

80. The method of claim 75 wherein determining whether the respective transition represented by the respective edge in the first motion planning graph will violate one or more safety rules of the set of safety monitoring rules of the processor-based workcell safety system includes determining whether the respective transition represented by the respective edge in the first motion planning graph will violate one or more of the safety rules that specify a safe distance to be maintained between the first robot and an object in the environment in which at least the first robot will operate.

81. The method of claim 75 wherein determining whether the respective transition represented by the respective edge in the first motion planning graph will violate one or more safety rules of the set of safety monitoring rules of the processor-based workcell safety system includes accounting for a granularity of one or more sensors of the processor-based workcell safety system in determining whether the respective transition represented by the respective edge in the first motion planning graph will violate one or more of the safety rules that specify a safe distance to be maintained between the first robot and an object in the environment in which at least the first robot will operate.

82. The method of claim 75, wherein the performing collision assessment by the processor-based motion planner for each edge of a first motion planning graph includes performing the collision assessment by the processor-based motion planner of the first robot control system for each edge of a first motion planning graph, and further comprising:
performing collision assessment by a processor-based motion planner of a second robot control system for each edge of a second motion planning graph, the second motion planning graph comprising a plurality of nodes and a plurality of edges, each of the nodes representing a respective configuration of a second robot and each of the edges representing a respective transition between a respective pair of the configurations of the second robot that are represented by a respective pair of the nodes that are connected by the respective edge;
for two or more of the edges of the second motion planning graph, determining whether a respective transition represented by the respective edge in the second motion planning graph will violate one or more safety rules of the set of safety monitoring rules of the processor-based workcell safety system that monitors the environment in which at least the first robot and the second robot will operate;
for each of the two or more edges of the second motion planning graph, setting a cost for the respective edge in the second motion planning graph based at least in part on both: i) the collision assessment and ii) the determination of whether a respective transition represented by the respective edge in the motion plan graph will violate one or more of the safety rules of the set of safety monitoring rules of the processor-based workcell safety system; and
generating a second executable motion plan based at least in part on the second motion planning graph with the cost set for each of the two or more edges, the second executable motion plan executable by the second robot control system to control operation of the second robot.

83. The method of claim 82, further comprising:
accessing, by the processor-based motion planner of the second robot control system, the first motion plan for the first robot;
representing the first robot as an obstacle based on the first motion plan, and wherein:
performing collision assessment by the motion planner of the second robot control system for each edge of a second motion planning graph includes performing collision assessment based on the first robot being represented as an obstacle.

84. The method of claim 75, further comprising:
performing collision assessment by the processor-based motion planner for each edge of a second motion planning graph, the second motion planning graph comprising a plurality of nodes and a plurality of edges, each of the nodes representing a respective configuration of a second robot and each of the edges representing a respective transition between a respective pair of the configurations of the second robot that are represented by a respective pair of the nodes that are connected by the respective edge;
for two or more of the edges of the second motion planning graph, determining whether a respective transition represented by the respective edge in the second motion planning graph will violate one or more safety rules of the set of safety monitoring rules of the processor-based workcell safety system that monitors the environment in which at least the first robot and the second robot will operate;
for each of the two or more edges of the second motion planning graph, setting a cost for the respective edge in the second motion planning graph based at least in part on both: i) the collision assessment and ii) the determination of whether a respective transition represented by the respective edge in the motion plan graph will violate one or more of the safety rules of the set of safety monitoring rules of the processor-based workcell safety system; and
generating a second executable motion plan based at least in part on the second motion planning graph with the cost set for each of the two or more edges, the second executable motion plan executable by a second robot control system to control operation of the second robot.

85. The method of claim 84, further comprising:
accessing the first motion plan for the first robot;
representing the first robot as an obstacle based on the first motion plan, and wherein:
performing collision assessment by the processor-based motion planner for each edge of a second motion planning graph includes performing collision assessment based on the first robot being represented as an obstacle.

86. The method of claim 75 wherein generating a first executable motion plan based at least in part on the first motion planning graph with the cost set for each of the two or more edges includes generating a first motion plan that reduces at least one of a stoppage, slowdown, or introduction of a precautionary occlusion.

87. The method of claim 75, further comprising:
predicting a behavior of a human in at least a portion of the environment in which at least the first robot will operate; and
wherein generating the first executable motion plan includes generating the first executable motion plan based in part on the predicted behavior of a human.

88. The method of claim 87, further comprising:
determining whether the human is acting consistently with the predicted behavior; and
in response to a determination that the human is not acting consistently with the predicted behavior, the generating the first executable motion plan includes generating the first executable motion plan that causes a slowing of movement of at least the first robot or causes another action that reduces a probability of the first robot colliding with an unpredictable behavior of the human.

89. The method of claim 75 wherein the generating the first executable motion plan based includes generating the first executable motion plan based on a resolution or granularity of at least one component of the processor-based workcell safety system.

90. The method of claim 75, further comprising:
controlling operation of the first robot based on the first motion plan.

91. A motion planning system that generates motion plans that are safety system aware, the motion plans executable to control one or more robots, the motion planning system comprising:
at least one processor-based motion planner that:
performs collision assessment for each edge of a first motion planning graph, the first motion planning graph comprising a plurality of nodes and a plurality of edges, each of the nodes representing a respective configuration of a first robot and each of the edges representing a respective transition between a respective pair of the configurations of the first robot that are represented by a respective pair of the nodes that are connected by the respective edge;
for two or more of the edges of the first motion planning graph, determines whether a respective transition represented by the respective edge in the first motion planning graph will violate one or more safety rules of a set of safety monitoring rules of a processor-based workcell safety system that monitors an environment in which at least the first robot will operate;
for each of the two or more edges of the first motion planning graph, sets a cost for the respective edge in the first motion planning graph based at least in part on both: i) the collision assessment and ii) the determination of whether a respective transition represented by the respective edge in the motion plan graph will violate one or more safety rules of the set of safety monitoring rules of the processor-based workcell safety system; and
generates a first executable motion plan based at least in part on the first motion planning graph with the cost set for each of the two or more edges, the first executable motion plan executable by a robot control system to control operation of at least the first robot.

92. The motion planning system of claim 91 wherein to set a cost for the respective edge in the first motion planning graph based at least in part on both: i) the collision assessment and ii) the determination of whether the respective transition represented by the respective edge in the motion plan graph will violate a safety rule of a set of safety monitoring rules of a processor-based workcell safety system the at least one processor-based motion planner sets the cost for the respective edge in the first motion planning graph where the cost represents an assessed probability of collision associated with the respective transition represented by the respective edge.

93. The motion planning system of claim 91 wherein to set a cost for the respective edge in the first motion planning graph based at least in part on both: i) the collision assessment and ii) the determination of whether respective transition represented by the respective edge in the motion plan graph will violate a safety rule of a set of safety monitoring rules of a processor-based workcell safety system the at least one processor-based motion planner sets the cost for the respective edge in the first motion planning graph where the cost represents an assessed probability of violation of at least one of the set of safety monitoring rules associated with the respective transition represented by the respective edge.

94. The motion planning system of claim 91 wherein to set a cost for the respective edge in the first motion planning graph based at least in part on both: i) the collision assessment and ii) the determination of whether respective transition represented by the respective edge in the motion plan graph will violate a safety rule of a set of safety monitoring rules of a processor-based workcell safety system the at least one processor-based motion planner sets the cost for the respective edge in the first motion planning graph where the cost represents an assessed probability of collision associated with the respective transition represented by the respective edge and represents an assessed probability of violation of at least one of the set of safety monitoring rules associated with the respective transition represented by the respective edge.

95. The motion planning system of claim 91 wherein to generate a first executable motion plan based at least in part on the first motion planning graph with the cost set for each of the two or more edges the at least one processor-based motion planner performs a least cost analysis on the first motion planning graph to identify a path between two configurations of the first robot.

96. The motion planning system of claim 91 wherein to determine whether the respective transition represented by the respective edge in the first motion planning graph will violate one or more safety rules of the set of safety monitoring rules of the processor-based workcell safety system the at least one processor-based motion planner determine whether the respective transition represented by the respective edge in the first motion planning graph will violate one or more of the safety rules that specify a safe distance to be maintained between the first robot and an object in the environment in which at least the first robot will operate.

97. The motion planning system of claim 91 wherein to determine whether the respective transition represented by the respective edge in the first motion planning graph will violate one or more safety rules of the set of safety monitoring rules of the processor-based workcell safety system, the at least one processor-based motion planner accounts for a granularity of one or more sensors of the processor-based workcell safety system in determining whether the respective transition represented by the respective edge in the first motion planning graph will violate one or more of the safety rules that specify a safe distance to be maintained between the first robot and an object in the environment in which at least the first robot will operate.

98. The motion planning system of claim 91, wherein to perform collision assessment for each edge of a first motion planning graph a processor-based motion planner of the first robot control system performs the collision assessment for each edge of a first motion planning graph, and further comprising:
a processor-based motion planner of a second robot control system that:
performs collision assessment by for each edge of a second motion planning graph, the second motion planning graph comprising a plurality of nodes and a plurality of edges, each of the nodes representing a respective configuration of a second robot and each of the edges representing a respective transition between a respective pair of the configurations of the second robot that are represented by a respective pair of the nodes that are connected by the respective edge;
for two or more of the edges of the second motion planning graph, determines whether a respective transition represented by the respective edge in the second motion planning graph will violate one or more safety rules of the set of safety monitoring rules of the processor-based workcell safety system that monitors the environment in which at least the first robot and the second robot will operate;
for each of the two or more edges of the second motion planning graph, sets a cost for the respective edge in the second motion planning graph based at least in part on both: i) the collision assessment and ii) the determination of whether a respective transition represented by the respective edge in the motion plan graph will violate one or more of the safety rules of the set of safety monitoring rules of the processor-based workcell safety system; and
generates a second executable motion plan based at least in part on the second motion planning graph with the cost set for each of the two or more edges, the second executable motion plan executable by the second robot control system to control operation of the second robot.

99. The motion planning system of claim 98, wherein:
the processor-based motion planner of the second robot control system accesses the first motion plan for the first robot;
the processor-based motion planner of the second robot control system represents the first robot as an obstacle based on the first motion plan, and
the processor-based motion planner of the second robot control system perform collision assessment for each edge of a second motion planning graph includes performing collision assessment based on the first robot being represented as an obstacle.

100. The motion planning system of claim 91, wherein the at least one processor-based motion planner further:
performs collision assessment by for each edge of a second motion planning graph, the second motion planning graph comprising a plurality of nodes and a plurality of edges, each of the nodes representing a respective configuration of a second robot and each of the edges representing a respective transition between a respective pair of the configurations of the second robot that are represented by a respective pair of the nodes that are connected by the respective edge;
for two or more of the edges of the second motion planning graph, determines whether a respective transition represented by the respective edge in the second motion planning graph will violate one or more safety rules of the set of safety monitoring rules of the processor-based workcell safety system that monitors the environment in which at least the first robot and the second robot will operate;
for each of the two or more edges of the second motion planning graph, set a cost for the respective edge in the second motion planning graph based at least in part on both: i) the collision assessment and ii) the determination of whether a respective transition represented by the respective edge in the motion plan graph will violate one or more of the safety rules of the set of safety monitoring rules of the processor-based workcell safety system; and
generates a second executable motion plan based at least in part on the second motion planning graph with the cost set for each of the two or more edges, the second executable motion plan executable by a second robot control system to control operation of the second robot.

101. The motion planning system of claim 100, wherein the at least one processor-based motion planner further:
accesses the first motion plan for the first robot;
represents the first robot as an obstacle based on the first motion plan, and wherein:
performs collision assessment for each edge of a second motion planning graph includes performing collision assessment based on the first robot being represented as an obstacle.

102. The motion planning system of claim 91 wherein to generate a first executable motion plan based at least in part on the first motion planning graph with the cost set for each of the two or more edges the at least one processor-based motion planner generates a first motion plan that reduces at least one of a stoppage, slowdown, or introduction of a precautionary occlusion.

103. The motion planning system of claim 91, wherein the at least one processor-based motion planner further:
predicts a behavior of a human in at least a portion of the environment in which at least the first robot will operate; and
wherein to generate the first executable motion plan the at least one processor-based motion planner generate the first executable motion plan based in part on the predicted behavior of a human.

104. The motion planning system of claim 103, wherein the at least one processor-based motion planner further:
determine whether the human is acting consistently with the predicted behavior; and
in response to a determination that the human is not acting consistently with the predicted behavior, to generate the first executable motion plan the at least one processor-based motion planner generates the first executable motion plan that causes a slowing of movement of at least the first robot or causes another action that reduces a probability of the first robot colliding with an unpredictable behavior of the human.

105. The motion planning system of claim 91 wherein to generate the first executable motion plan based the at least one processor-based motion planner generates the first executable motion plan based on a resolution or granularity of at least one component of the processor-based workcell safety system.

106. The motion planning system of claim 91, wherein the at least one processor-based motion planner further:
controls operation of the first robot based on the first motion plan.
